(19) United States
(12) Patent Application Publication
(10) Pub. No.: US 2014/0161564 A1
(43) Pub. Date: Jun. 12, 2014

(54) BLADE AND BINDING DEVICE

(71) Applicant: KOKUYO CO., LTD., Osaka-Shi (JP)

(72) Inventor: Hirokazu Aoi, Osaka-shi (JP)

(73) Assignee: KOKUYO CO., LTD., Osaka-Shi (JP)

(21) Appl. No.: 14/180,941

(22) Filed: Feb. 14, 2014

Related U.S. Application Data
(62) Division of application No. 12/998,471, filed on Apr. 25, 2011.

(30) Foreign Application Priority Data
Nov. 12, 2008 (JP) 2008-290344

(51) Int. Cl. B42B 5/00; B26F 1/22

(52) U.S. Cl. CPC B42B 5/00; B26F 1/22
USPC 412/16; 83/660

(57) ABSTRACT

A blade which is a part of a binding device forms a binding hole and a cut hole and binds a plurality of sheet bodies together by using a cut and raised piece cut raised out of the binding hole and the cut hole, the blade includes a core, an outer covering including a sheet metal and covering an outside of the core, and a cutting edge including a curved portion having a curved arc shape in a bottom view and liner portions extending from both ends of the curved portion in the bottom view, the cutting edge being continuous in a U shape and formed at a tip end of the outer covering, the curved portion includes a blade tip end portion and an adjacent portion adjacent to the blade tip end portion.

The present application is a Divisional application of U.S. patent application Ser. No. 12/998,471, filed on Apr. 25, 2011, which is based on International Application No. PCT/JP2009/068656, filed on Oct. 30, 2009, which is based on the Japanese Patent Application No. P2008-290344, filed on Nov. 12, 2008, the entire contents of which are incorporated herein by reference.

### TECHNICAL FIELD

The present invention relates to a file system for binding a plurality of sheet bodies with a file.

### BACKGROUND ART

Conventionally, as this type of file system, there is a known system for properly bind a plurality of sheets of paper with staples to form brochures, forming binding holes in the brochures, and binding them in a file for storage or browse.

As a staple for binding a plurality of sheets of paper into a form of a brochure, there is a well-known metal staple (see Patent Document 1, for example). Recently, there is strong demand for reduction of environmental burdens and the above-mentioned brochure is required to be separated into the paper and the staples which are made of different materials in many cases in disposing of the brochure in order to facilitate recycling of resources. However, removal of the metal staples from the paper or the like requires intricate work and disposal of a large volume of paper or the like requires a lot of time and trouble (first problem). This is the problem not only for the paper but similarly for binding of sheet bodies made of synthetic resin.

Documents bound into brochures are bound in a file after binding holes are formed in the documents with a punch in many cases and the normal file is made up of a cover made of paper or synthetic resin and a binder having metal parts and attached to the cover. Therefore, to dispose of a large number of files expiring storage periods at once, in addition to the above-mentioned work, separation of the file and the brochures, separation of the paper forming the brochures and the staples, and separation of the cover and the binder forming the file need to be repeated for many hours and the time and trouble for such work are immeasurable in an office in which a large number of documents are stored (second problem).

### RELATED-ART DOCUMENT

### Patent Document

Patent Document 1: Japanese Patent Application Laid-Open No. 2004-230483

### SUMMARY OF THE INVENTION

### Problem to be Solved by the Invention

It is an object of the present invention to solve at least the above-described first problem without significantly reducing filing efficiency.

### Approach to Solve the Problems

To achieve the above object, the invention employs the following structure. A file system according to the invention includes a brochure formed by forming a binding hole in a plurality of sheet bodies made of the same material and binding the plurality of sheet bodies together by using a cut and raised piece cut and raised out of the binding hole and a file for binding the brochure by using the binding hole, in which a bound portion of the brochure is compressed and deformed in a thickness direction.

Here, compression and deformation of the bound portion means that the bound portion is deformed into such a state as not to be able to return into a shape immediately after the binding by elasticity of the sheet bodies.

With this structure, the plurality of sheet bodies are bound by the cut and raised piece cut and raised out of the binding hole and therefore the cut and raised piece having a function of a staple and the sheet bodies are made of the same material. As a result, it is unnecessary to remove the staple in disposal to thereby solve the above-described first problem. Because the bound portion by the cut and raised piece is compressed and deformed, it is possible to suppress bulkiness of the bound portion. As a result, it is possible to bind a large number of brochures in the file to thereby avoid a problem of significant reduction in filing efficiency as compared with a case in which metal staples are used.

To solve the second problem as well as the first problem, the file may be made of the same material as the brochure.

In this way, the brochure does not need to be detached from the file in disposal and it is possible to dispose of the file in which the large number of sheet bodies are bound as it is.

Specifically, the sheet bodies are sheets of paper and the file includes a paper cover and a paper binder accompanying the cover.

Although the one binding hole may be provided, the plurality of biding holes may be formed in each of the sheet bodies to correspond to a pitch of binding rods of the binder if a file having the plurality of binding rods is used.

The binding rods may be relatively rigid pipe-shaped rods, elastically deformable wire-shaped rods, flexible string-shaped rods, and the like.

To bind the sheet bodies with the cut and raised piece, preferably, the binding hole on one end of which the cut and raised piece remains and a pulling-up cut hole and provided in a vicinity of the one end of the binding hole are respectively provided in the stacked plurality of sheet bodies and the cut and raised piece of the sheet bodies is inserted through the pulling-up cut hole to thereby bind the sheet bodies together.

As a brochure used for this file system, there is provided a brochure in which a binding hole is formed in a plurality of sheet bodies made of the same material, the plurality of sheet bodies are bound together by using a cut and raised piece cut and raised out of the binding hole, and a bound portion is compressed and deformed.

As a preferable binding device for forming the brochure, there is provided a binding device including: a punching blade capable of turning between a punching attitude and a turning attitude and forming a binding hole in the punching attitude; a cutting blade provided to be adjacent to the punching blade and having a window for receiving the punching blade which has turned to the turning attitude; a stage for retaining sheet bodies so that they face tip ends of the punching blade and the cutting blade; a punching plate provided on the stage to form the binding hole in the sheet bodies on the stage in cooperation with the punching blade; a punching mechanism for causing the punching blade and the cutting blade to penetrate the sheet bodies retained on the stage from a one face side; a punching blade turning mechanism for turning the punching blade which has penetrated the sheet bodies to the turning attitude to insert a cut and raised piece cut and raised out of the binding hole to the other face side into the window in the cutting blade; a blade withdrawing mechanism for withdrawing the cutting blade retaining the cut and raised piece in its window to the one face side of the sheet bodies together with the cut and raised piece; and a compressing mechanism for compressing and deforming a bound portion formed by inserting the cut and raised piece through the pulling-up cut hole in a thickness direction.

### Effects of the Invention

According to the invention, it is possible to provide the file system in which the brochures formed by binding the sheet bodies can be bound effectively in the file, because the bound portion is not bulky. Moreover, it is possible to dispose of the brochure as it is without separation when the brochure becomes unnecessary.

### BRIEF DESCRIPTION OF THE DRAWINGS

FIG. 1 A plan view of a brochure and showing an embodiment of the present invention.

FIG. 2 An enlarged sectional view of a part of a bound portion of the brochure in the embodiment.

FIG. 3 A perspective view showing a state of use of the brochure in the embodiment and bound in a file.

FIG. 4 A general schematic diagram of a binding device in a first embodiment of the invention.

FIG. 5 A plan schematic diagram of the binding device in the embodiment.

FIG. 6 A sectional view along a line X-X in FIG. 5 and in a state in which an actuating handle is not operated.

FIG. 7 A sectional view along a line X-X in FIG. 5 and in a state in which the actuating handle is pressed.

FIG. 8 A schematic diagram showing a punching mechanism in the embodiment.

FIG. 9 A schematic diagram showing the punching mechanism in the embodiment.

FIG. 10 A schematic diagram showing a turning mechanism in the embodiment.

FIG. 11 A schematic diagram showing a blade withdrawing mechanism in the embodiment.

FIG. 12 A schematic diagram showing a compressing mechanism in the embodiment.

FIG. 13 A general schematic diagram of a binding device in a second embodiment of the invention.

FIG. 14 A plan schematic diagram of the binding device in the embodiment.

FIG. 15 A plan view of an inner housing of the embodiment.

FIG. 16 A schematic diagram showing an essential portion of the binding device in the embodiment.

FIG. 17 A sectional view along a line Y-Y in FIG. 14 and in a state in which an actuating handle is not operated.

FIG. 18 A sectional view along a line Y-Y in FIG. 14 and in a state in which the actuating handle is pressed.

FIG. 19 A perspective view of a cutting blade in the embodiment.

FIG. 20 A sectional view along a line Z-Z in FIG. 13.

FIG. 21 A schematic diagram showing a punching mechanism in the embodiment.

FIG. 22 A schematic diagram showing the punching mechanism in the embodiment.

FIG. 23 A schematic diagram showing a turning mechanism in the embodiment.

FIG. 24 A schematic diagram showing a blade withdrawing mechanism in the embodiment.

FIG. 25 A schematic diagram showing a blade withdrawing mechanism in the embodiment.

FIG. 26 A schematic diagram showing a compressing mechanism in the embodiment.

FIG. 27 A plan view schematically showing a shape of a pulling-up cut hole in another embodiment of the invention.

FIG. 28 A plan view schematically showing a shape of a pulling-up cut hole in another embodiment of the invention.

FIG. 29 A plan view schematically showing a shape of a pulling-up cut hole in another embodiment of the invention.

FIG. 30 A plan view schematically showing a shape of a pulling-up cut hole in another embodiment of the invention.

FIG. 31 A plan view schematically showing a shape of a pulling-up cut hole in another embodiment of the invention.

FIG. 32 A plan view schematically showing a shape of a pulling-up cut hole in another embodiment of the invention.

FIG. 33 A plan view schematically showing a shape of a pulling-up cut hole in another embodiment of the invention.

FIG. 34 A perspective view of a cutting blade in another embodiment of the invention.

FIG. 35 A perspective view of a cutting blade in yet another embodiment of the invention.

FIG. 36 A front view of a punching blade according to a first variation of the invention.

FIG. 37 A perspective view of the punching blade in the variation.

FIG. 38 A schematic diagram showing an essential portion of a binding device according to the variation.

FIG. 39 A front view of a punching blade according to a second variation of the invention.

FIG. 40 A perspective view of the punching blade in the variation.

FIG. 41 A schematic diagram showing an essential portion of a binding device according to the variation.

FIG. 42 A front view of a punching blade according to a third variation of the invention.

FIG. 43 A perspective view of the punching blade in the variation.

FIG. 44 A schematic diagram showing an essential portion of a binding device according to the variation.

FIG. 45 A front view of a punching blade according to a fourth variation of the invention.

FIG. 46 A perspective view of the punching blade in the variation.

FIG. 47 A schematic diagram showing an essential portion of a binding device according to the variation.

FIG. 48 A perspective view of a cutting blade and a punching blade according to a fifth variation of the invention.

### MODES FOR CARRYING OUT THE INVENTION

### First Embodiment

An embodiment of the present invention will be described below with reference to the drawings.

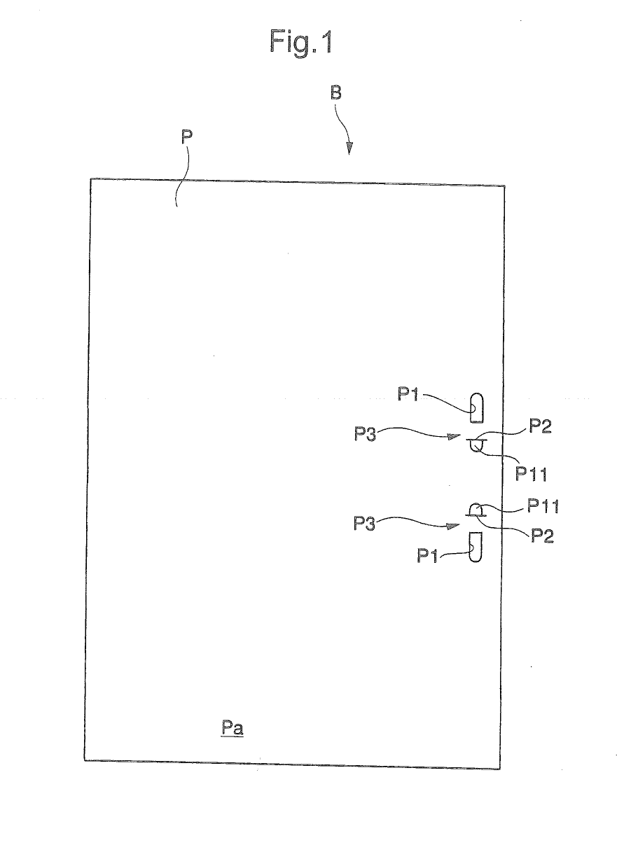

As shown in FIGS. 1 to 3, this file system is for binding one or a plurality of brochure(s) B with a file F.

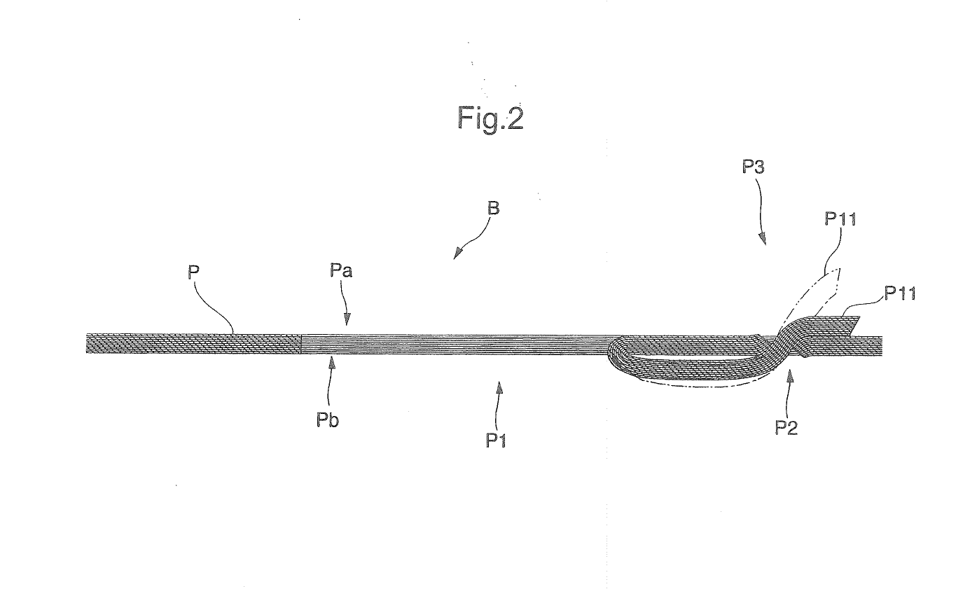

As shown in FIGS. 1 and 2, the brochure B is formed by binding a plurality of sheet bodies made of the same material, e.g., a plurality of sheets of paper P and the sheets of paper P are bound together at two bound portions P3 set on a bound side. Each of the bound portions P3 includes a binding hole P1 formed in the respective sheets of paper P by a punching blade 92 penetrating from a one face Pa side of the sheet of paper P, a pulling-up cut hole P2 formed in the respective sheets of paper P to be adjacent to the binding hole P1, and a cut and raised piece P11 cut and raised out of the binding hole P1 to the other face Pb side of the paper P. By introducing a tip end side of the cut and raised piece P11 to the one face Pa side of the paper P through the cut hole P2, the bound sides of the plurality of sheets of paper P are bound together. The binding hole P1 has semicircular arc-shaped one end and the other end continuous with a base end of the cut and raised piece P11. The binding holes P1 pairing up with each other are arranged with the other ends thereof facing each other and a distance between one ends thereof, which are the farthest from each other, corresponding to a pitch of binding rods F21 of the file F. To put it concretely, for example, a distance between centers of curvatures of the one ends of the opposite binding holes P1 is set to 80 mm which is the pitch of the binding rods F21 of the file F and a width of the binding holes P1 is set to a dimension a little longer than 6 mm corresponding to a width of the binding rods F21.

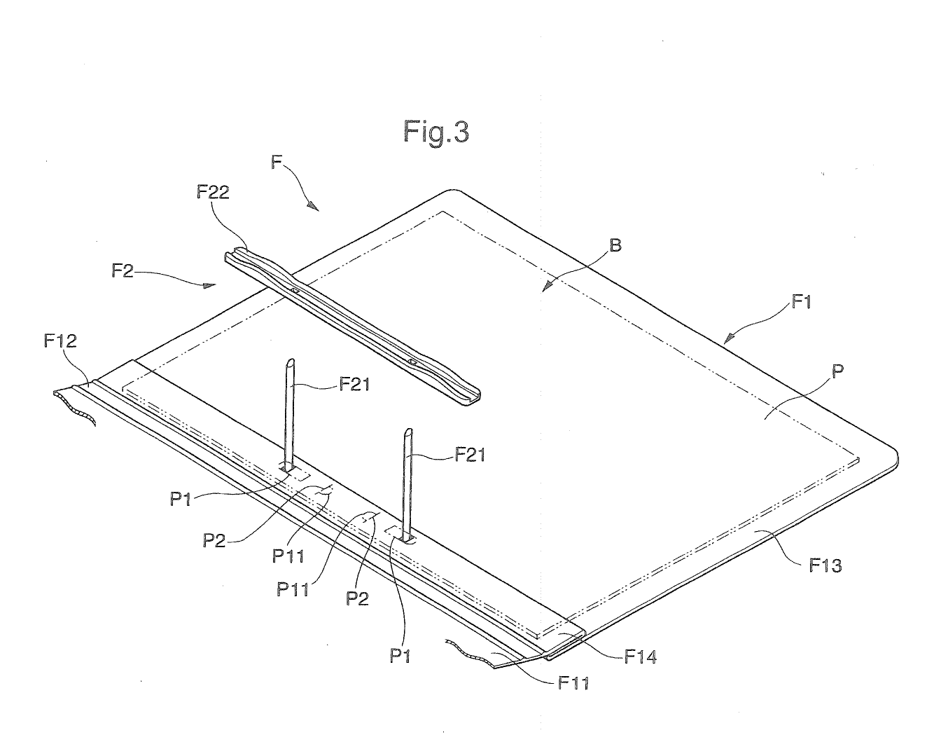

As shown in FIG. 3, the file F is made of the same material as the brochure B. To put it concretely, the file F includes a paper cover F1 and a paper binder F2 accompanying the cover F1. The cover F1 includes a front cover F11, a spine F12, a back cover F13, and a folded mounting portion F14 formed between the spine F12 and the back cover F13 and is formed by folding a sheet of cardboard. As shown in Japanese Patent Application Laid-Open No. 2005-35265, for example, the binder F2 includes binding rods F21 provided to the folded mounting portion F14 and paring up with each other to be inserted into the binding holes P1 in the brochure B and a binding plate member F22 for retaining ends of the binding rods F21 penetrating the brochure B and the binding rods F21 and the binding plate member F22 are respectively made of paper.

In such a file system, both of the brochure B and the file F are made of paper and therefore it is unnecessary to separate the parts made of different materials in disposing of them. Consequently, by employing such a file system, it is possible to dispose of the brochure B made up of only the plurality of sheets of paper P and the file F as they are after the storage period expires to thereby save a lot of time and trouble required for the separation.

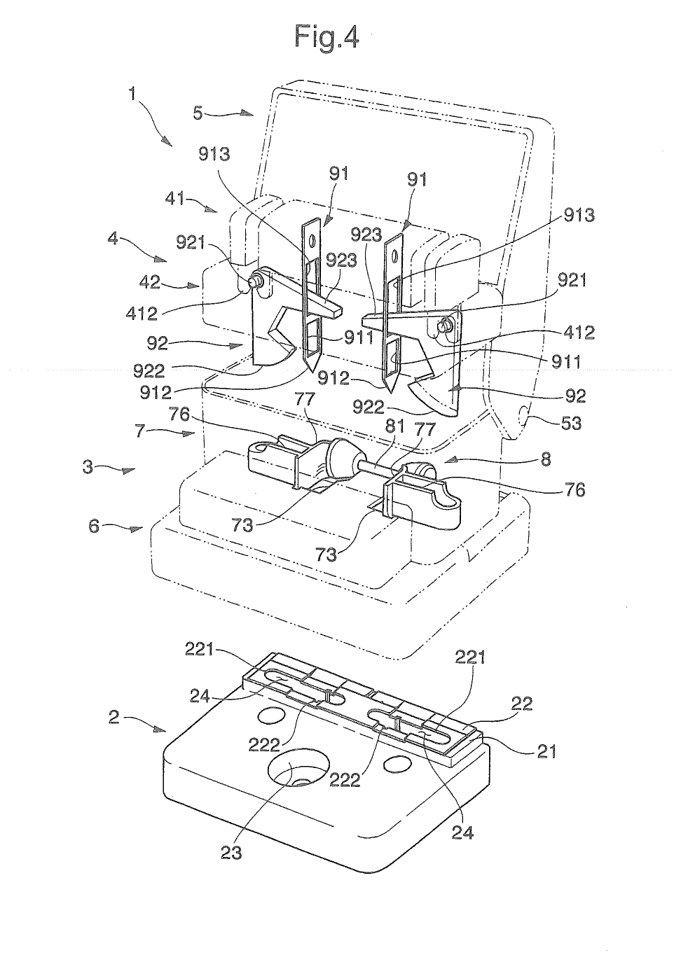

Next, a binding device 1 directly used for carrying out this file system will be described with reference to FIGS. 4 to 12.

This binding device 1 is for binding the plurality of sheets of paper P to form the brochure B and includes a stage 2 to be placed on a desk, a main body 3 retained on the stage 2 to move up and down, a replaceable blade unit 4 housed in the main body 3 to move up and down and having punching blades 92 and cutting blades 91, which will be described later, and an actuating handle 5 having a front end portion mounted to the main body 3 to be rotatable about a shaft 53 as shown in FIG. 4.

The stage 2 is a board-shaped member having a mount 21, which is rectangular in a plan view and protruding on a front edge side of an upper face of the stage 2, and includes a punching plate 22 on the mount 21 and for forming the binding holes P1 in the paper P in cooperation with the punching blades 92 as shown in FIGS. 4, 6, and 7. The punching plate 22 is made of metal and has punching portions 221 through which the punching blades 92 pass and passage holes 222 through which the cutting blades 91 pass and cavities 24 for allowing insertion of the punching blades 92 and the cutting blades 91 and turning of the inserted punching blades 92 are formed under the punching plate 22. In the upper face of the stage 2, a retaining recessed portion 23 in which an elastic body such as a coil spring S1 for elastically supporting the main body 3 is mounted is formed.

As shown in FIGS. 4, 6, and 7, the main body 3 includes a lower housing 6 fitted over the stage 2 to move up and down and having a paper receiving face 61 on its front half portion and an upper housing 7 integrally provided on the lower housing 6 with a lower face of its front half portion facing the paper receiving face 61 through a clearance for insertion of the paper P.

As shown in FIGS. 4, 6, and 7, the lower housing 6 is in a shape of a bottomless box and has the paper receiving face 61 formed on the front half portion of its upper wall and a positioning window 62 which is formed at a portion of the paper receiving face 61 and in which the mount 21 of the stage 2 is fitted to be able to relatively move up and down. Between a back half portion of the upper wall of the lower housing 6 and the stage 2, elastic bodies for biasing the main body 3 upward, e.g., a plurality of coil springs S1 are interposed.

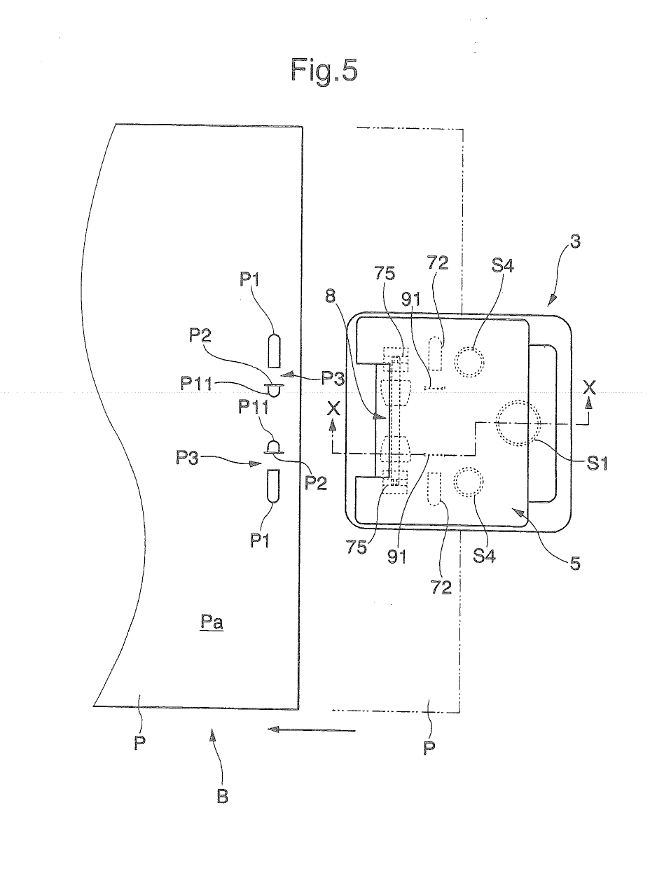

Punching blade insertion holes 72 through which the punching blades 92 pass are formed in a bottom wall 71 of the upper housing 7 as shown in FIG. 5 and guide walls 76 for preventing lateral wobbling of the punching blades 92 are formed around the punching blade insertion holes 72 as shown in FIG. 4. Cutting blade insertion holes 73 through which the cutting blades 91 pass are formed in the bottom wall 71 and a lock wall 77 is provided between each of the cutting blade insertion holes 73 and each of the punching blade insertion holes 72. The upper housing 7 is provided with compression rollers 8 pairing up with each other for compressing and deforming the bound portions P3. In other words, the compression rollers 8 pairing up with each other are supported on a common shaft 81 and the bottom wall 71 is provided with roller exposing windows 74 for exposing lower end portions of both the rollers 8 to the paper receiving face 61 side and shaft support portions 75 for supporting the shaft 81 so that the shaft 81 can move parallel in a vertical direction as shown in FIG. 5. The shaft 81 is biased downward by elastic bodies, e.g., coil springs S2 and both the compression rollers 8 are elastically pressed against the paper receiving face 61 by this elastic biasing force. The replaceable blade unit 4 is housed to move up and down in the upper housing 7 of the main body 3.

As shown in FIGS. 4, 6, and 7, the replaceable blade unit 4 is a bottomless box-shaped member including a lower member 42 to be fitted in an inner periphery of the upper housing 7 of the main body 3 to be vertically movable and an upper member 41 integrally provided at a central portion of an upper wall of the lower member 42. Provided in the upper member 41 are punching blade retaining portions 412 for supporting the punching blades 92 in such a manner that the blades 92 can turn and are detachable and cutting blade retaining portions 411 for retaining the cutting blades 91 in hanging attitudes in such a manner that the blades 91 are detachable.

As shown in FIGS. 4 and 8 to 12, each of the punching blades 92 includes a shaft 921 at its base end and a blade main body 922 for forming the binding hole P1 at its tip end and the shaft 921 is detachably supported by the punching blade retaining portion 412 provided to a ceiling wall of the replaceable blade unit 4. From the base end of the punching blade 92, an arm 923 for turning the punching blade 92 protrudes. The punching blades 92 paring up with each other are disposed with tip ends of their arms 923 facing each other and retained in punching attitudes 92(H) in which the blade main bodies 922 are disposed substantially right under the shafts 921 with their arms 923 biased downward by a common elastic body, e.g., a coil spring S3. When the replaceable blade unit 4 moves down, lower faces of the arms 923 come in contact with upper edges of the lock walls 77 provided to the main body 3. After the contact, the replaceable blade unit 4 further moves down so that the punching blades 92 can turn into turning attitudes 92(R) against elasticity of the coil spring S3. In other words, immediately after the punching blades 92 punch the sheets of paper P set on the paper receiving face 61 and the blade main bodies 922 enter a lower side of the punching plate 22, the arms 923 come in contact with the upper edges of the lock walls 77. In this contact states, the punching blades 92 further move down to thereby turn into the turning attitudes 92(R).

On the other hand, as shown in FIGS. 4 and 6 to 12, each of the cutting blades 91 is a flat plate-shaped blade having a blade main body 912 at its tip end and mounted and fixed with a screw or the like (not shown) to a rail-shaped cutting blade retaining portion 411 provided in the replaceable blade unit 4. On a tip end side of the cutting blade 91, a window 911 for receiving a portion of the blade main body 922 of the punching blade 92 which has turned to the turning attitude 92(R) is formed. On a base end side of the cutting blade 91, a through hole 913 through which the arm 923 passes is formed to prevent interference between the cutting blade 91 and the arm 923. The upper member 41 of the replaceable blade unit 4 formed as described above protrudes upward through an opening in a lid portion 31 mounted to an opening portion at an upper end of the upper housing 7 of the main body 3 and the replaceable blade unit 4 can be moved up and down by operating the upper member 41 with the actuating handle 5.

As shown in FIGS. 4 to 7, the actuating handle 5 has a front edge mounted at its opposite end portions to the main body 3 with a shaft 53 interposed therebetween and has a pressing body 51 for pressing an upper face of the ceiling wall of the replaceable blade unit 4 on an inner face of a middle portion of the handle 5. Arms 52 are provided to protrude from opposite sides of the pressing body 51 of the actuating handle 5 and tip end portions of the arms 52 are connected to the upper member 41 of the replaceable blade unit 4 by using a shaft (not shown).

In this embodiment, the punching mechanism in the invention is mainly made up of the replaceable blade unit 4 retaining the punching blades 92 and the cutting blades 91 and the actuating handle 5 for pressing the replaceable blade unit 4 downward to cause the punching blades 92 and the cutting blades 91 to penetrate the sheets of paper P set on the punching plate 22. A punching blade turning mechanism in the invention is mainly made up of the punching blade retaining portions 412 for supporting the shafts 921 of the punching blades 92 for turning, the arms 923 provided to the base ends of the punching blades 92, and the lock walls 77 provided to the main body 3 to receive the arms 923 and apply turning forces to the punching blades 92 when the punching blades 92 move down. A blade withdrawing mechanism is mainly made up of the replaceable blade unit 4 retaining the punching blades 92 and the cutting blades 91 and coil springs S4 which are elastic bodies for biasing the replaceable blade unit 4 upward by using the main body 3 as a foothold. By connecting the replaceable blade unit 4 and the actuating handle 5 by the shaft as in the embodiment, it is possible to further enhance performance of the blade withdrawing mechanism. In other words, even if there are a large number of sheets of paper P and forces of the coil springs S4 are not enough to pull the cut and raised pieces P11 out to the one face Pa side of the paper P, it is possible to complete the pulling out by applying an upward operating force to the actuating handle 5. A compressing mechanism in the invention is mainly made up of the rollers 8, the elastic body, i.e., the coil spring S2 for elastically pressing the rollers 8 against the paper receiving face 61.

Next, actuation of the binding device 1 will be described.

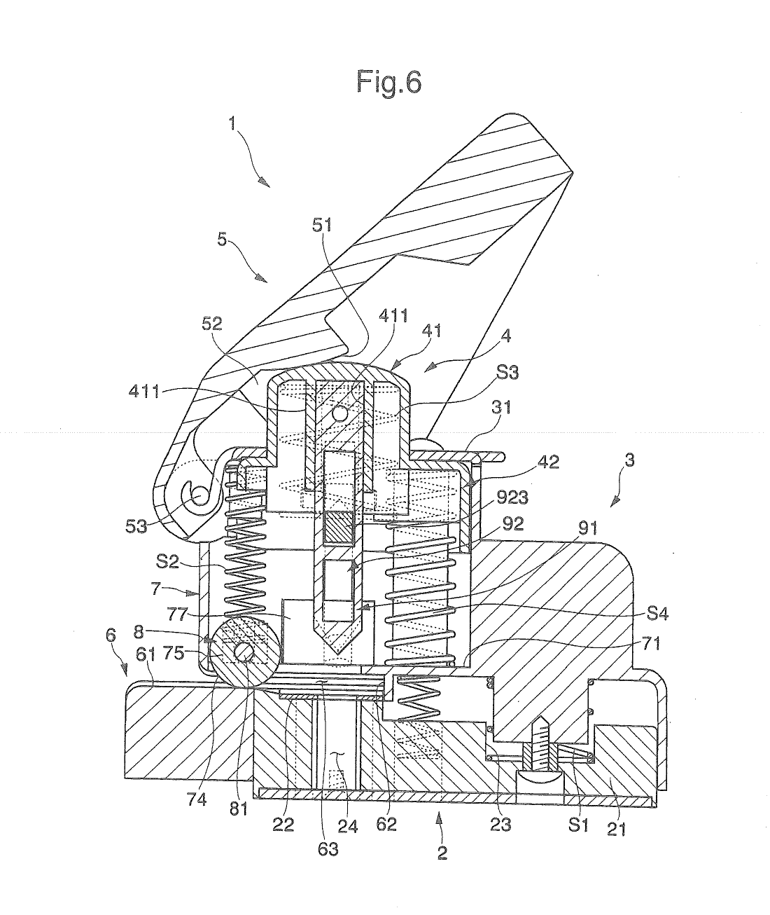

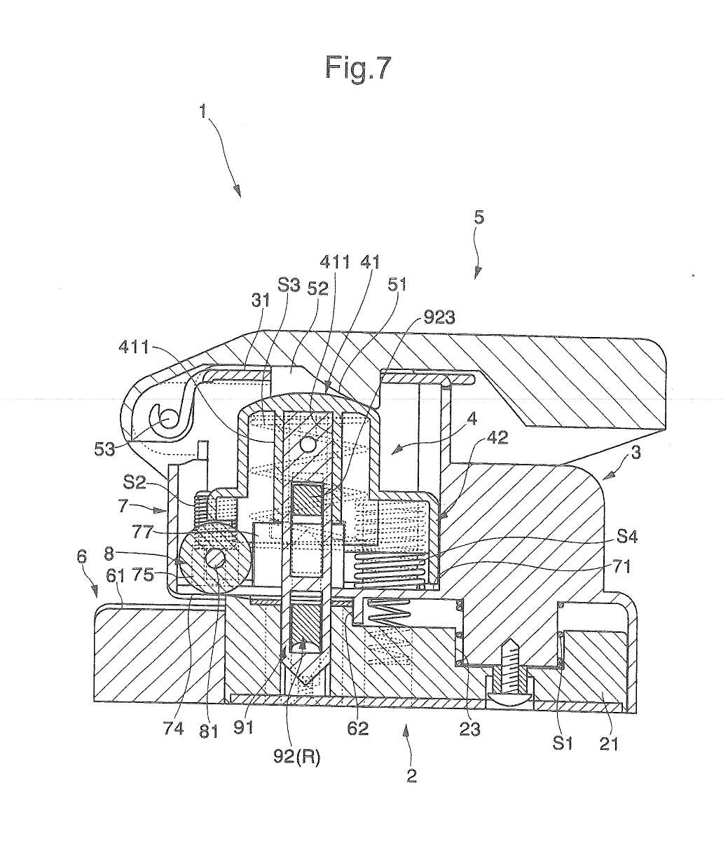

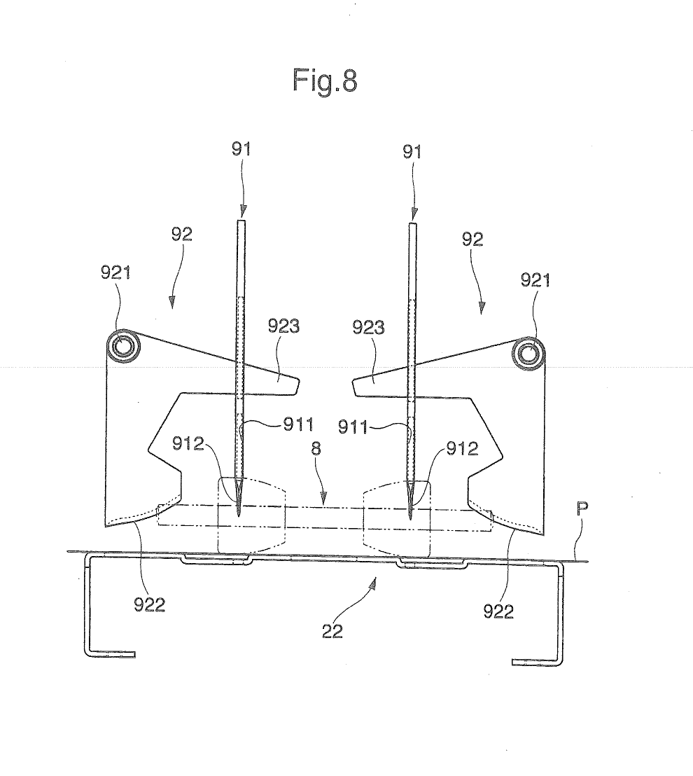

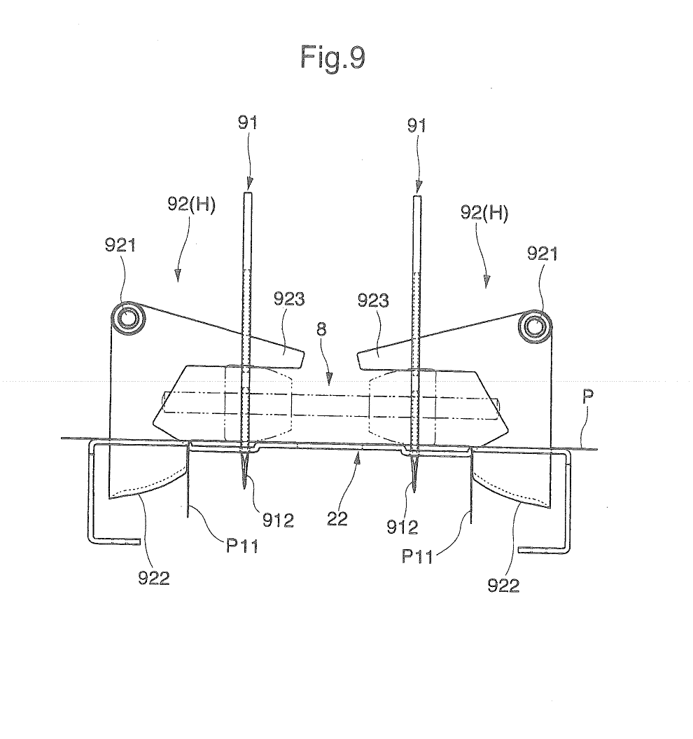

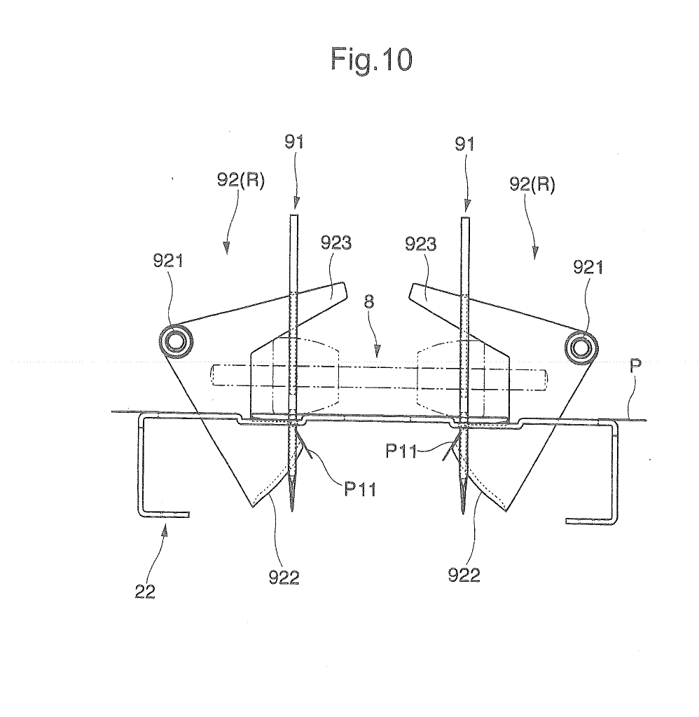

In a state in which the actuating handle 5 is not operated, as shown in FIGS. 6 and 8, the main body 3 and the replaceable blade unit 4 are respectively retained in their upper limit positions and the punching blades 92 are maintained in the punching attitudes 92(H). In this state, as shown by an imaginary line in FIG. 5, the plurality of stacked sheets of paper P are inserted all the way through the clearance 63 along the paper receiving face 61. Then, by operating the actuating handle 5 downward, the replaceable blade unit 4 moves down against biasing forces of the coil springs S4 to such positions that the punching blades 92 and the cutting blades 91 come in contact with the one face Pa of the paper P. By further operating the actuating handle 5 downward from this position, as shown in FIGS. 7 and 9, the punching blades 92 and the cutting blades 91 penetrate the paper P to form the binding holes P1 and the cut holes P2 in the paper P. If the punching blades 92 and the cutting blades 91 further move down after the punching, as shown in FIG. 10, the arms 923 of the punching blades 92 come in contact with the lock walls 77 and the punching blades 92 turn to the turning attitudes 92(R). As a result, the tip ends of the cut and raised pieces P11 cut and raised out of the binding holes P1 to the other face Pb side of the paper P are inserted into the windows 911 in the cutting blades 91.

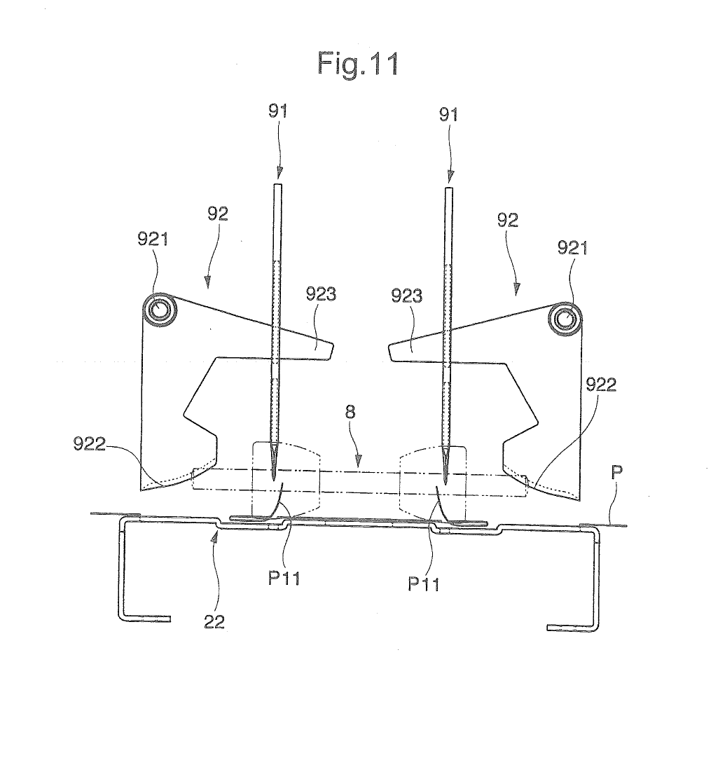

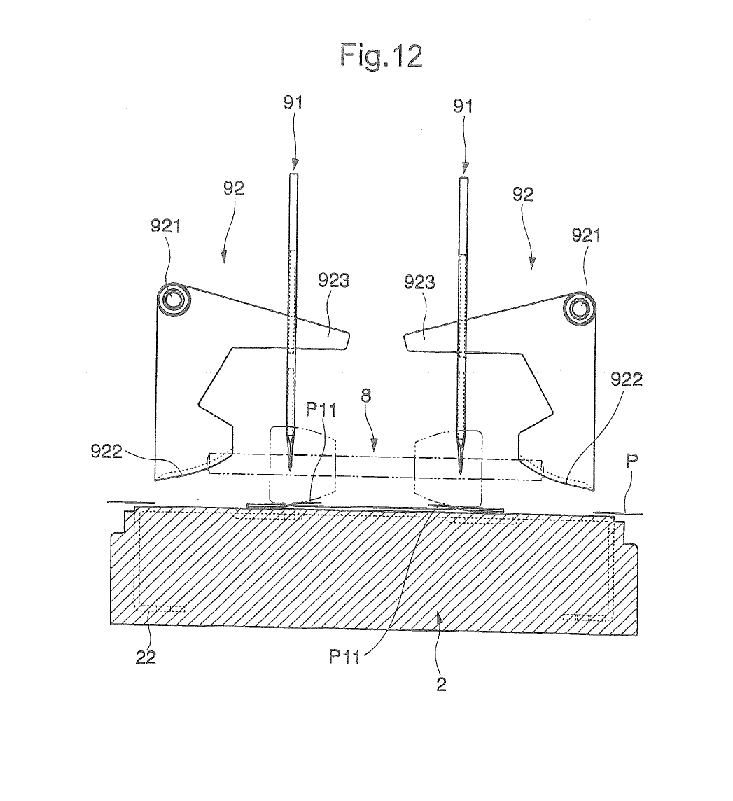

Then, by stopping operation of the actuating handle 5, as shown in FIG. 11, the punching blades 92 return from the turning attitudes 92(R) to the punching attitudes 92(H), the punching blades 92 and the cutting blades 91 move up due to biasing by the coil springs S4 and are withdrawn from the paper P. At this time, the cut and raised pieces P11 inserted into the windows 911 in the cutting blades 91 are pulled out to the one face Pa side of the paper P through the cut holes P2 and the plurality of sheets of paper P are bound by the cutting blades 91. If the punching blades 92 and the cutting blades 91 are withdrawn from the paper P in this manner, the main body 3 which has been moved down to the lowermost position under a load of the punching is moved up to the initial raised position by the biasing force of the coil spring 51 and the sheets of paper P are separated from the punching plate 22. If the sheets of paper P are withdrawn from the binding device 1 in this state, on their way, the bound portions P3 of the sheets of paper P are compressed and deformed in a thickness direction by outer peripheral faces of the compression rollers 8 provided to the main body 3 and the paper receiving face 61 as shown in FIG. 12 and the brochure B described above is formed. If the elastic forces of the coil springs S4 are not enough to withdraw the punching blades 92 and the cutting blades 91 to the one face Pa side of the paper P, the actuating handle 5 may be operated upward to assist the withdrawal.

With the above structure, the file system according to the embodiment includes the brochure B each formed by forming the binding holes P1 in the plurality of sheets of paper P and binding the plurality of sheets of paper P together by using the cut and raised pieces P11 cut and raised out of the binding holes P1 and the file F for binding the brochure B by using the binding holes P1 and the bound portions P3 of the brochure B are compressed and deformed in the thickness direction. Because the plurality of sheets of paper P are bound by the cut and raised pieces P11 cut and raised out of the binding holes P1 and the cut and raised pieces P11 having a function of staples and the paper P are made of the same material, i.e., paper, it is unnecessary to remove the staples in disposal, intricate work such as removal of the metal staples from the paper P is unnecessary, and it is possible to dispose of a large volume of paper P without a lot of time and trouble. Because the bound portions P3 bound by the cut and raised pieces P11 are compressed and deformed into such a state as not to be able to return into shapes immediately after the binding by elasticity of the paper P, it is possible to suppress bulkiness of the bound portions P3. As a result, it is possible to bind a large number of brochure B in the file F to thereby avoid a problem of significant reduction in filing efficiency as compared with a case in which metal staples are used.

Because the file F includes the paper cover F1 and the paper binder F2 accompanying the cover F1 and is made of the same material as the brochure B, i.e., paper, it is not necessary at all to separate the parts made of the different materials in disposal. Consequently, by employing such a file system, it is possible to dispose of the brochure B made up of only the plurality of sheets of paper P and the file F as they are after the storage period expires to thereby save a lot of time and trouble required for the separation.

Because the two binding holes P1 are respectively formed in each of the sheets of paper P and the binding holes P1 are formed to correspond to the pitch of the binding rods F21 of the binder F2, it is possible to use them to bind the sheets of paper P in the file F having the two binding rods F21.

Because the binding holes P1 at one ends of which the cut and raised pieces P11 remain and the pulling-up cut holes P2 near the one ends of the binding holes P1 are formed respectively in the plurality of stacked sheets of paper P and the cut and raised pieces P11 of the sheets of paper P are inserted through the pulling-up cut holes P2 to bind the sheets of paper P together, the sheets of paper P can be bound together by using the cut and raised pieces P11 and the binding holes P1 can be used for binding in the file F.

Used for such a file system are the brochure B each formed by forming the binding holes P1 in the plurality of sheets of paper P, binding the plurality of sheets of paper P together by using the cut and raised pieces P11 cut and raised out of the binding holes P1, and compressing and deforming the bound portions P3. Therefore, it is unnecessary to remove the staples indisposing of the brochure B, intricate work such as removal of the metal staples from the paper P is unnecessary, and it is possible to dispose of a large volume of paper P without a lot of time and trouble.

Used as the binding device 1 suitable for forming of the brochure B is the binding device 1 including the punching blades 92 for turning from the punching attitudes 92(H) to the turning attitudes 92(R) and for forming the binding holes P1 in the punching attitudes 92(H), the cutting blades 91 provided to be adjacent to the punching blades 92 and having the windows 911 for receiving the punching blades 92 which have turned to the turning attitudes 92(R), the stage 2 for retaining the paper P so that the paper P faces the tip ends of the punching blades 92 and the cutting blades 91, the punching plate 22 provided on the stage 2 to form the binding holes P1 in the paper P on the stage 2 in cooperation with the punching blades 92, the punching mechanism for causing the punching blades 92 and the cutting blades 91 to penetrate the paper P retained on the stage 2 from the one face Pa side, the punching blade turning mechanism for turning the punching blades 92 which have penetrated the paper P to the turning attitudes 92(R) to insert the cut and raised pieces P11, which have been cut and raised to the other face Pb side out of the binding holes P1, into the windows 911 in the cutting blades 91, the blade withdrawing mechanism for puling the cutting blades 91 retaining the cut and raised pieces P11 in their windows 911 to the one face Pa side of the paper P together with the cut and raised pieces P11, and the compressing mechanism for compressing and deforming the bound portions P3, which have been formed by inserting the cut and raised pieces P11 through the pulling-up cut holes P2, in the thickness direction. Therefore, when a user carries out a series of operations, i.e., pressing and releasing of the actuating handle 5 provided to the binding device 1, the binding holes P1 are formed in the plurality of sheets of paper P and the plurality of sheets of paper P are bound together by using the cut and raised pieces P11 cut and raised out of the binding holes P1 to form the brochure B having the compressed and deformed bound portions P3.

### Second Embodiment

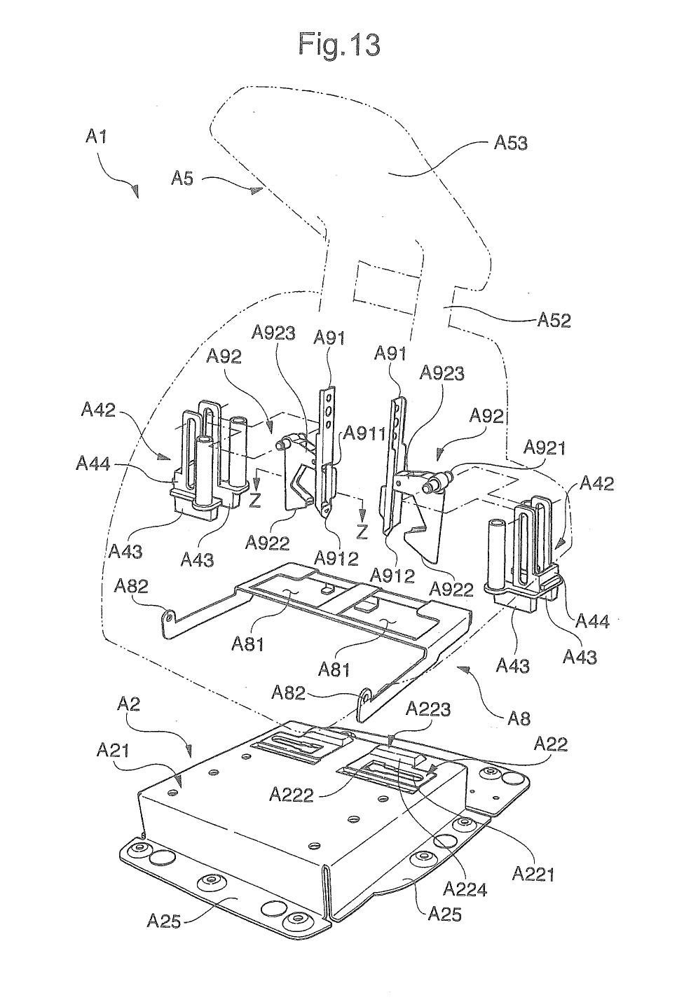

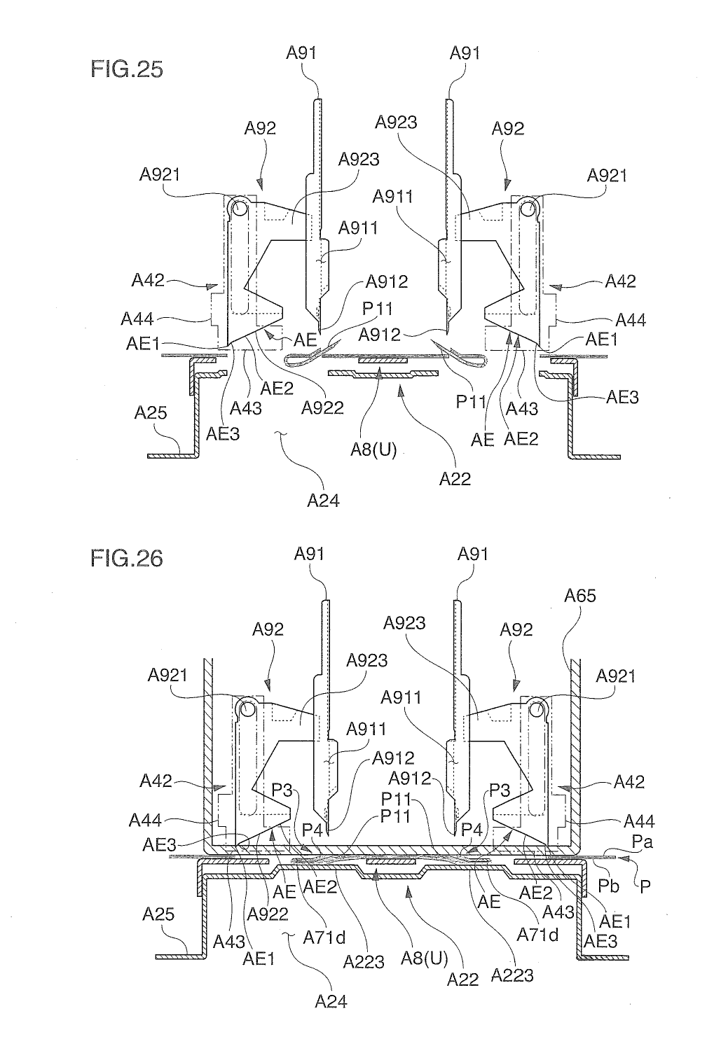

Next, a binding device A1 directly used for carrying out this file system will be described with reference to FIGS. 13 to 26.

This binding device A1 is for binding a plurality of sheets of paper P to make the brochure B and includes a stage A2 to be placed on a desk, a main body A3 secured to the stage A2, left and right replaceable blade units A4 pairing up with each other, housed to move up and down in the main body A3, and having punching blades A92 and cutting blades A91, which will be described later, a paper base A8 for raising the bound sheets of paper P when the replaceable blade units A4 have finished punching operations and moved up, and an actuating handle A5 mounted to the main body A3 to be able to turn in a vertical direction to actuate the paper base A8 and the replaceable blade units A4 as shown in FIG. 13.

The stage 2 includes a flat box-shaped mount A21 to which a lower end portion of the main body A3 is mounted and punching plates A22 integrally formed on a ceiling wall A21a of the mount A21 as shown in FIGS. 13, 17, and 18. The mount A21 is in a shape of a flat box open on a lower face side and has, at its open end, base flanges A25 having installation bodies A25a. A cavity A24 for receiving the cutting blades A91 and the punching blades A92 penetrating the punching plates A22 to enter is formed inside the mount A21. The cavity A24 is isolated from the outside by a duster case A26 mounted to the lower face side of the mount A21. The punching plates A22 are formed integrally with the ceiling wall A21a in forming the mount A21 by press work and include passage holes A222 through which the cutting blades A91 pass and punching portions A221 through which the punching blades A92 pass. In the embodiment, bump portions A223 for pinching cut and raised pieces P11, which will be described later, from below are provided at positions of the ceiling wall A21a of the mount A21 on an insertion side of the paper P of the punching plates A22. Each of the bump portions A223 is formed integrally by deforming the ceiling wall A21a of the mount A21 and has, on the punching plate A22 side, a slope A224 for guiding the cut and raised piece P11 in pulling out of the paper P.

As shown in FIGS. 13 to 18, the main body A3 includes an outer housing A31 mounted to cover the mount A21 and an inner housing A32 disposed in the outer housing A31 and fixed to the mount A21.

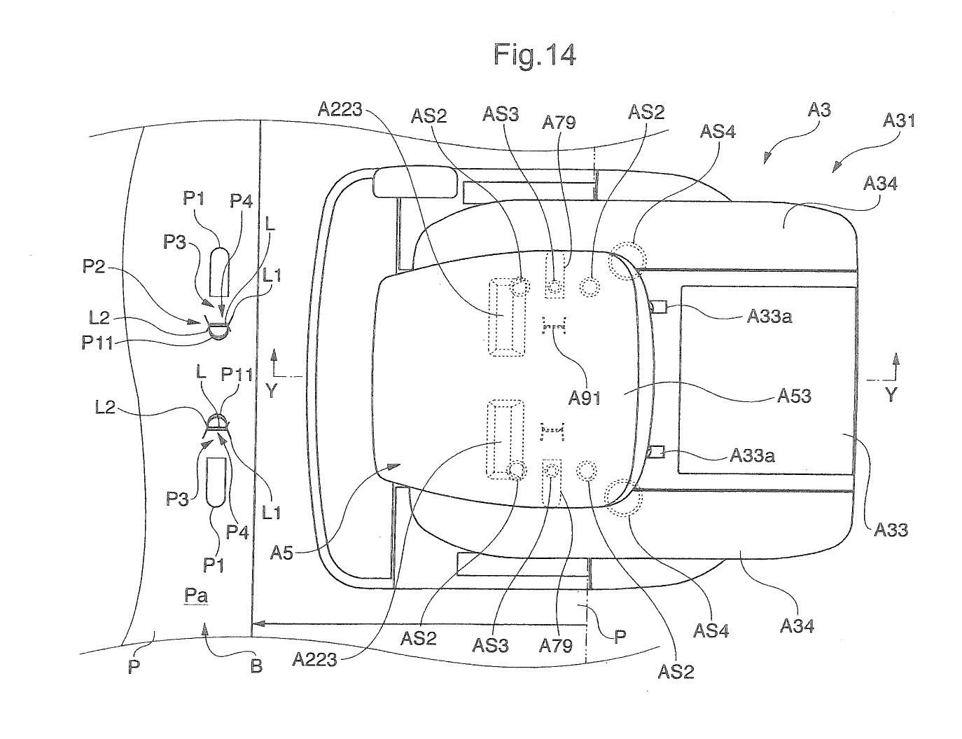

As shown in FIGS. 14, 17, and 18, the outer housing A31 includes a top cover A33 covering a space over the mount A21, side covers A34 covering opposite side faces of the space above the mount A21, and a front cover A35 covering a front face of the space above the mount A21. The top cover A33 is in a curved shape gradually lowering toward a back side and has slits A33a through which arms A52 of the actuating handle A5 pass. The front cover A35 includes an upper wall A35a, a front wall A35b, and a bottom wall A35c and has slits (not shown) continuous with the slits A33a in the upper wall A35a. Between a lower face of the bottom wall A35c of the front cover A35 and an upper face of the mount A21, a paper insertion clearance A35d into which the paper P is inserted is formed.

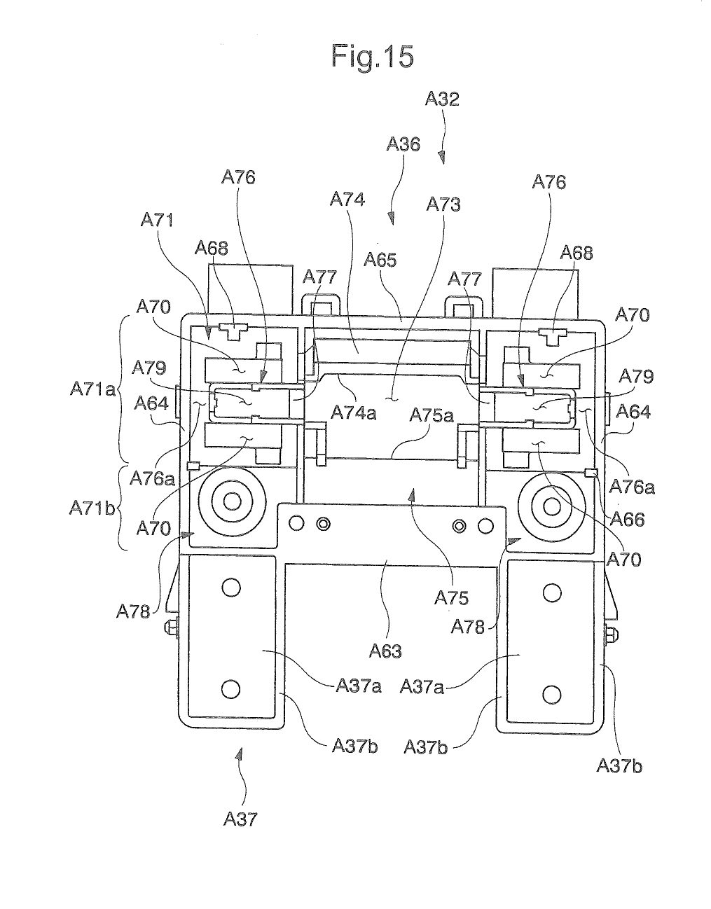

As shown in FIGS. 15 to 18, the inner housing A32 includes a cylindrical housing main body A36 having substantially the same lateral width as the mount A21 and mounting portions A37 integrally formed on a back face side of the housing main body A36 and used for rigidly connecting the housing main body A36 to the upper face of the mount A21 with screws A38 which are fastening members.

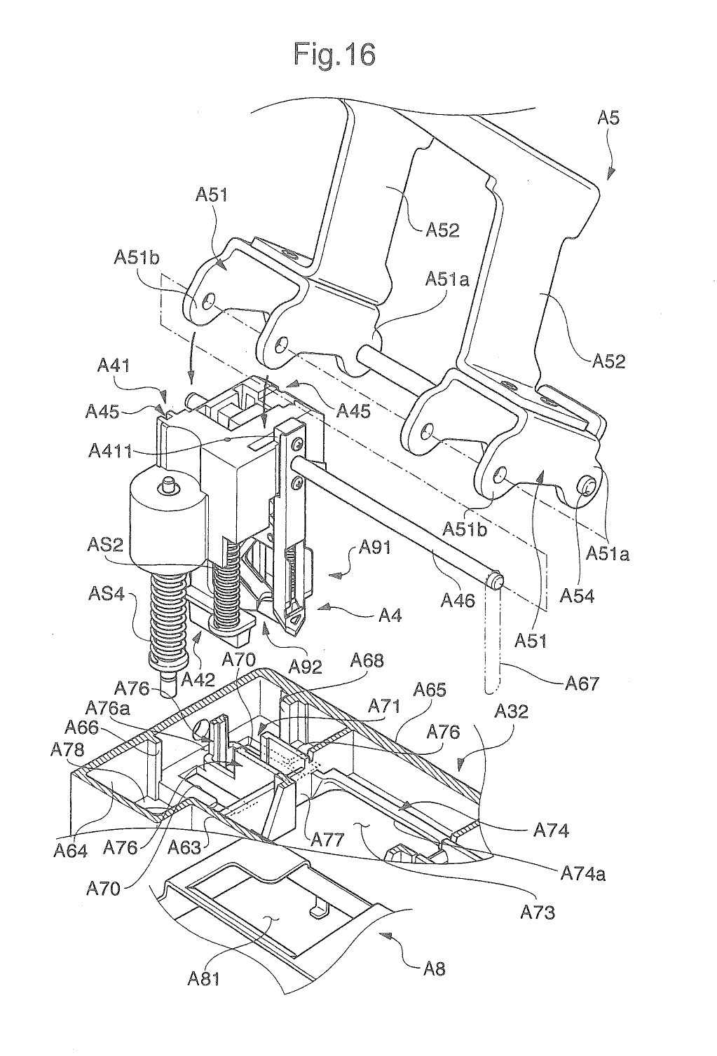

As shown in FIGS. 15 and 16, the housing main body A36 includes a back wall A63 provided with the mounting portions A37, left and right side walls A64 extending forward from left and right opposite ends of the back wall A63, a front wall A65 provided between front ends of the opposite side walls A64, and a bottom wall A71 provided from a lower edge of the front wall A65 to the back wall A63. Each of the side walls A64 has, on its inner face, a rail A66 for guiding an upper block A41, which will be described later, of the replaceable blade unit A4 while maintaining the upper block A41 in a vertical attitude and a vertical slit A67 for guiding a drive shaft A46 for moving the replaceable blade units A4 up and down. The front wall A65 has, on its inner face, rails A68 for guiding the upper block A41, which will be described later, of the replaceable blade unit A4 in the vertical direction while maintaining the upper block A41 in the vertical attitude.

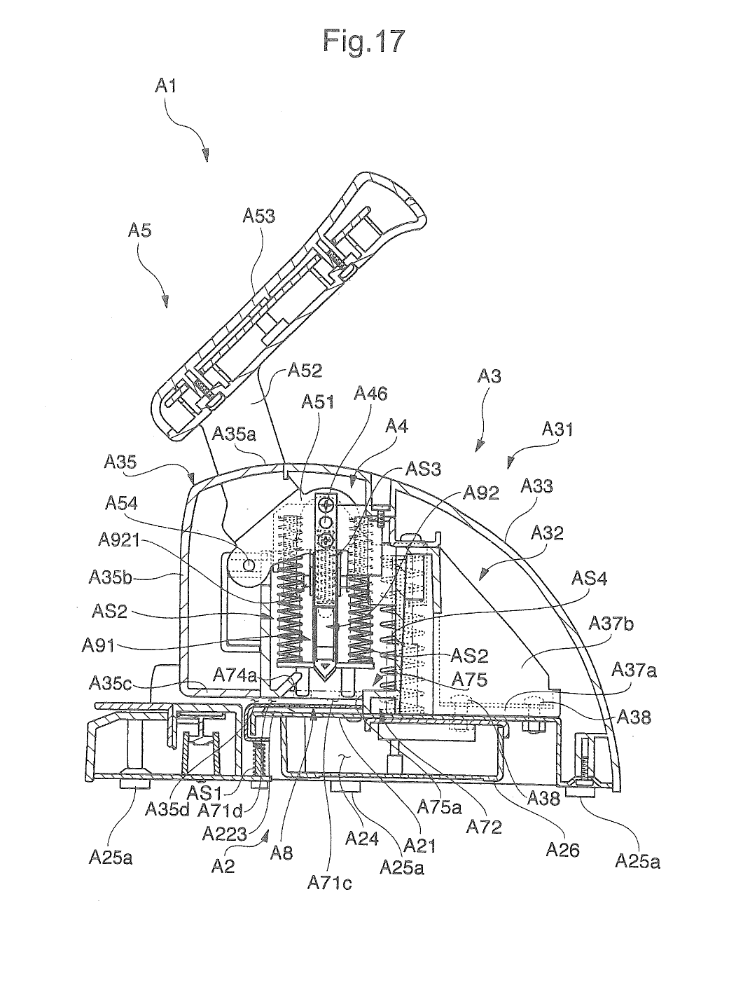

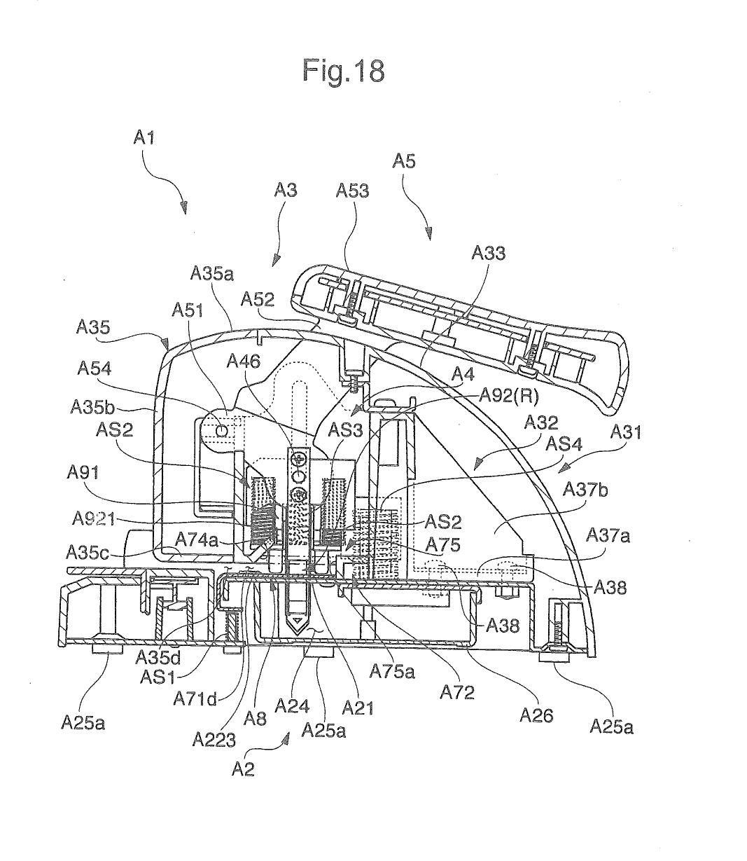

As shown in FIGS. 15 to 18, the bottom wall A71 is formed by integrating a back half portion A71b in close contact with the upper face of the mount A21 and a front half portion A71a having a clearance A71c between the mount A21 and itself with a step portion A72 interposed between the back half portion A71b and the front half portion A71a and has a window A73 for receiving the cut and raised pieces P11 of the bound sheets of paper P at a center in a left-right direction of the front half portion A71a. An upward piece A74 forming a portion of the bottom wall A71 is formed on a front edge side of the window A73 and the upward piece A74 is provided with a slope A74a for guiding the cut and raised pieces P11 in pulling out of the paper P. A bent wall A75 bent downward is formed on a rear edge side of the window A73 and the bent wall A75 is provided with a lock face A75a for locking tip ends of the sheets of paper P. Provided at left and right opposite end portions of the front half portion A71a of the bottom wall A71 are punching blade penetrating holes A79 through which the punching blades A92 described later pass and paper retainer penetrating holes A70 through which paper retainers A43 described later pass. Provided at an opening edge on an upper face side of each of the punching blade penetrating holes A79 are a guide wall A76 for guiding the punching blade A92 while maintaining the blade A92 in a vertical attitude and a lock wall A77 for locking an arm A923 of the punching blade A92 described later. At left and right opposite end portions of the back half portion A71b of the bottom wall A71, spring receiving portions A78 for receiving coil springs AS4 for biasing the replaceable blade units A4 described later are provided. FIGS. 17 and 18 are sectional views along a line Y-Y in FIG. 14, in which the rising walls around the replaceable blade units A4 including the lock walls A77 are omitted in order to clearly show the replaceable blade unit A4 described later.

As shown in FIGS. 15, 17, and 18, each of the mounting portions A37 includes a bottom plate portion A37a continuous with the bottom wall A71 of the housing main body A36 and a reinforcing rib A37b for connecting the bottom plate portion A37a and the back wall A63 of the housing main body A36 and the bottom plate portion A37a is mounted to the mount A21 by using the screws A38 which are the fastening members.

The above-mentioned left and right replaceable blade units A4 are housed in the inner housing A32 formed as described above.

As shown in FIGS. 13 and 16, each of the replaceable blade units A4 includes the upper block A41 which can move up and down while guided and maintained in the vertical attitude by the rails A66 and A68 of the inner housing A32, the cutting blade A91 mounted to the upper block A41, the punching blade A92 disposed to be adjacent to the cutting blade A91 and mounted on the upper block A41 by a shaft A921 to be able to turn in the left-right direction, a coil spring AS3 for biasing the punching blade A92 to turn it toward a punching attitude (H) described later, a lower block A42 which can move up and down with respect to the upper block A41 while guided by the shaft A921 of the punching blade A92, and a coil spring AS2 for elastically biasing the lower block A42 downward with respect to the upper block A41.

As shown in FIG. 16, the upper block A41 is in a shape of a block having engaged portions A45 to be engaged with the rails A66 and A68 of the inner housing A32 for sliding and is connected to actuation ends A51b of the actuating handle A5 by the drive shaft A46. The upper block A41 is in the shape of a box open downward, can house an upper half portion of the punching blade A92, and has bearing portions (not shown) for supporting the shaft A921 provided to an upper end portion of the punching blade A92 in such a manner that the shaft A921 can turn. The upper block A41 also has a mounting portion A411 for mounting the cutting blade A91 to an outer side face of the upper block A41 and the drive shaft A46 penetrates the cutting blade A91 mounted to the mounting portion A411.

As shown in FIGS. 13 and 16, the lower block A42 is provided at its lower end portion with the front and back paper retainers A43 paring up with each other. Base end portions of the paper retainers A43 are connected by a horizontal member A44. Both the paper retainers A43 are always fitted in paper retainer insertion holes A70 provided to the bottom wall A71 of the inner housing A32 in such a manner that they can move up and down. In this way, the whole lower block A42 including the paper retainers A43 can be maintained in the vertical attitude.

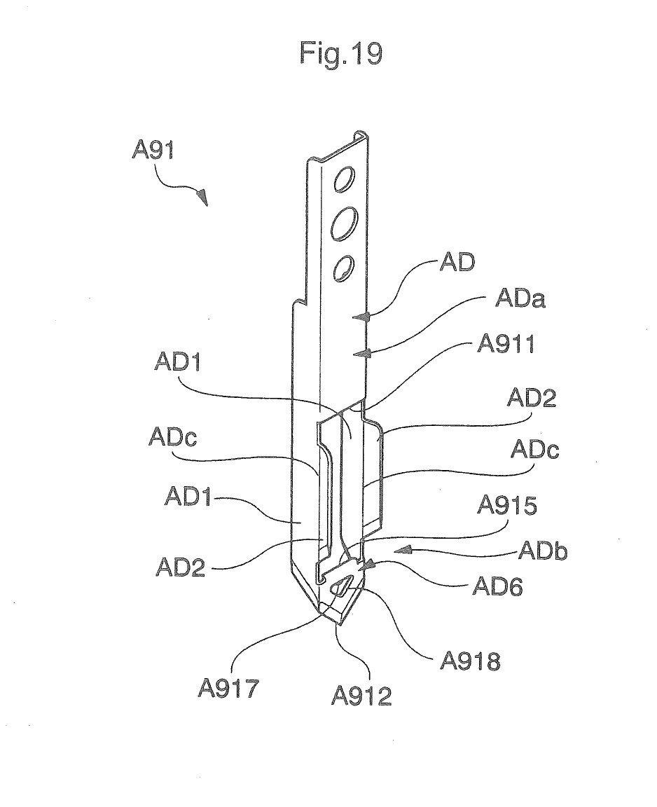

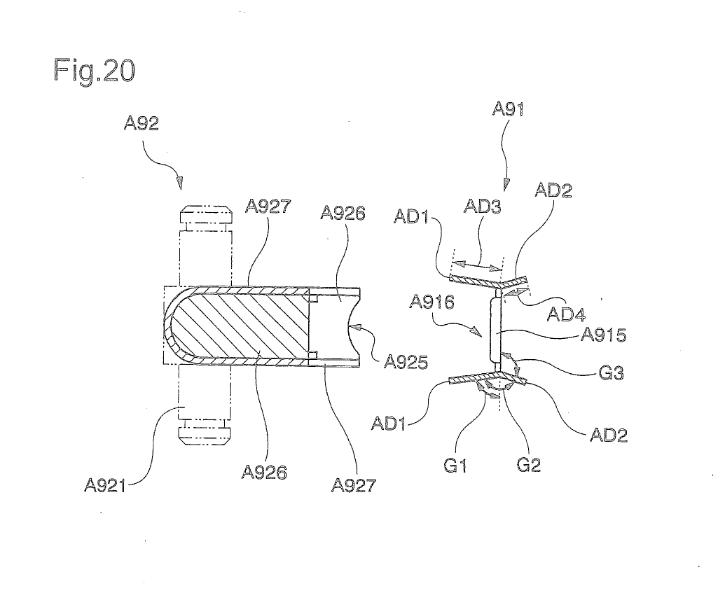

As shown in FIGS. 19 and 20, each of the cutting blades A91 is for forming a substantially H-shaped cut hole P2. To put it concretely, it is for forming the cut hole P2 made up of a straight main slit L, first sub-slits L1 bent to extend from opposite ends of the main slit L in one direction, i.e., toward a side on which the punching blade A92 corresponding to this cutting blade A91 is disposed, and second sub-slits L2 bent to extend from the opposite ends of the main slit L in the other direction, i.e., toward an opposite side from the side on which the punching blade A92 corresponding to this cutting blade A91 is disposed, each of the first sub-slits L1 and each of the second sub-slits L2 forming a certain angle G2 with each other. In specifications intended to bind a relatively large number of sheets of paper P as in the embodiment, the first sub-slits L1 are longer than the second sub-slits L2. This is for allowing passage of the cut and raised piece P11 without a hitch when the cut and raised piece P11 is pulled up to the upper face side, i.e., the one face Pa side of the paper P and a tongue piece portion P4 surrounded with the main slit L and the first sub-slits L1 is also pulled up to the one face Pa side of the paper P together with the cut and raised piece P11. In other words, a bent-direction length AD3 of each of first sub-blades AD1 described later is set to be greater than a bent-direction length AD4 of each of second sub-blades AD2. In other words, the cutting blade A91 is formed by punching and bending a sheet metal and includes a main blade AD for forming the main slit L, the first sub-blades AD1 for forming the first sub-slits L1, and the second sub-blades AD2 for forming the second sub-slits L2. The main blade AD is divided into an upper blade portion ADa and a lower blade portion ADb having a blade main body A912 by a window A911 for receiving the punching blade A92 and the upper blade portion ADa and the lower blade portion ADb are structurally connected by the first sub-blades AD1. In the embodiment, the first sub-blades AD1 have base end edges which are integrally continuous with opposite side edges of the main blade AD at bent line portions ADc forming angles G1 slightly smaller than the right angle and the second sub-blades AD2 are continuously formed at portions of the base end edges of the first sub-blades AD1 and corresponding to the window A911. In other words, the second sub-blades AD2 are cut and raised out of the window A911 by bending the sheet metal material at the bent line portions ADc. Before the cutting and raising, the second sub-blades AD2 are preliminarily cut and raised to form angles G2 smaller than 180° with respect to the first sub-blades AD1. As a result, though each of the first sub-blades AD1 is bent at the angle G1 slightly smaller than the right angle, a cut and raised angle G3 of the second sub-blades AD2 with respect to the main blade AD is greater than 90° in the end.

Because the first sub-blades AD1 and the second sub-blades AD2 are respectively formed by bending the one main blade AD, it is possible to obtain strength of the whole cutting blade A91. Furthermore, at a lower edge of the window A911 in the cutting blade A91, a smooth guide portion A915 for smoothly guiding the cut and raised piece P11 of the paper P is provided. The smooth guide portion A915 is formed by rolling and bending down a surplus material A916 at the lower edge of the window A911. A tip end A917 of the surplus material A916 enters a receiving window A918 formed in the main blade AD to prevent interference between the tip end A917 and the paper P. Each of the blade main body A912 of the cutting blade A91, i.e., the blade formed on the main blade AD and blades respectively formed on the first sub-blades AD1 and the second sub-blades AD2 has a double-edged structure having a cutting edge at a center in a thickness direction of the material.

As shown in FIGS. 13 and 20, each of the punching blades A92 includes the shaft A921 at its base end portion and a blade main body A922 for forming the binding hole P1 at its tip end and the shaft A921 is supported for turning on the bearing portions (not shown) provided to the upper block A41 of the replaceable blade unit A4. From the base end of the punching blade A92, the arm A923 for turning the punching blade A92 protrudes.

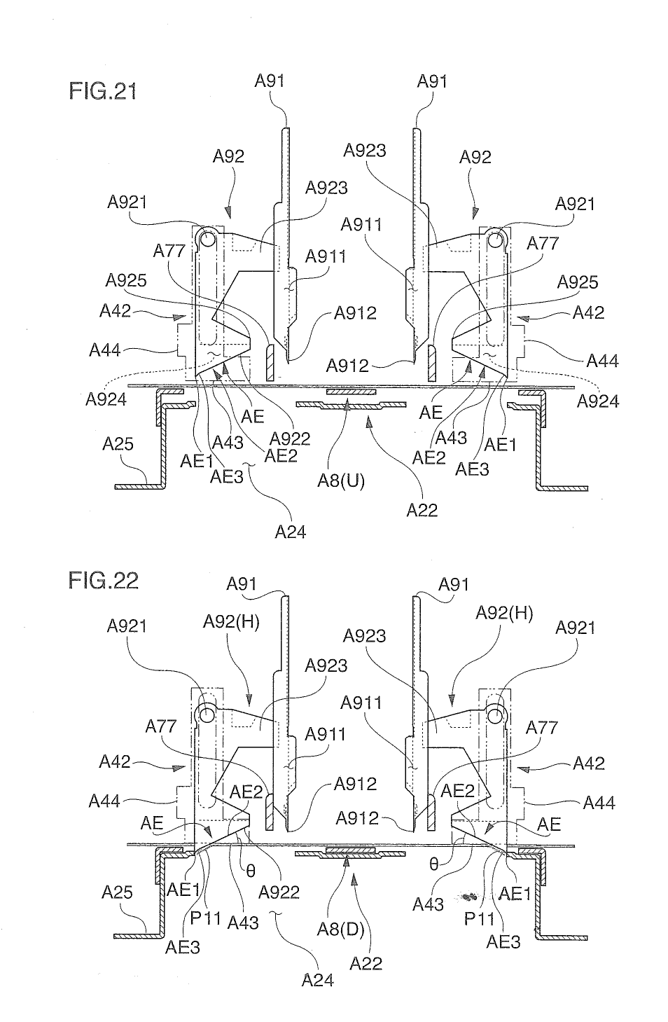

As shown in FIG. 21, the blade main body A922 is provided at a lower end portion of the punching blade A92 and has a cutting edge AE continuous in a U shape in a bottom view. The cutting edge AE has a shape formed by a smooth curved line and is inclined so that its angle with respect to the punching plate A22 at a position of contact between the punching blade A92 and the punching plate A22 changes as the punching blade A92 penetrates. The inclined portion includes a blade tip end portion AE1 which penetrates the paper P first. In other words, an entry angle which the cutting edge AE makes with the punching plate A22 at the blade tip end portion AE1 is set to be greater than the entry angle 6 at the other portion AE2 of the blade main body A922. Here, the entry angle 6 is an angle which the one face Pa of the paper P supported on the punching plate A22 makes with the cutting edge AE immediately before entering the paper P and the entry angle 6 is set to gradually reduce as the punching blade A92 penetrates in the embodiment. Therefore, after the blade tip end portion AE1 is sharply stuck into the paper P, the paper P is cut along the cutting edge AE from a portion of the paper P which the blade penetrates earlier. In other words, when the blade main body A922 penetrates the paper P, the blade tip end portion AE1 first comes in contact with a portion of the paper P, which is almost a point, and then punching is carried out while a punching distance by the blade main body A922 and the cutting edge AE increases with respect to their penetrating distance.

As shown in FIGS. 20 and 21, in an upper space surrounded with the cutting edge AE, a shelter space A924 for allowing the cut and raised piece P11 cut and raised by the blade main body A922 to shelter is provided and a pushing-out portion A925 for inserting the cut and raised piece P11 into the window A911 formed in the cutting blade A91 is provided above the shelter space A924.

As shown in FIG. 20, each of the punching blades A92 is made up of a core A926 made of resin and an outer covering A927 made of a sheet metal and covering an outside of the core A926. To put it concretely, the blade main body A922 is formed at a tip end of the outer covering A927 and the arm A923 is made up of the core A926 and the outer covering A927. The shelter space A924 is formed by a lower face of the core A926 and an inner face of the outer covering A927 and the pushing-out portion A925 is formed by a tip end edge of the core A926. The pushing-out portion A925 is recessed in a partial arc shape in a plan view and can preferentially bias opposite side edges of the cut and raised piece P11 in pressing the cut and raised piece P11.

As shown in FIGS. 13 and 21, the punching blades A92 pairing up with each other are disposed with tip ends of the arms A923 facing each other and are retained in the punching attitudes (H) in which the blade main bodies A922 are disposed substantially right under the shafts A921 with their arms A923 biased downward by the elastic bodies, e.g., the coil springs AS3. At this time, the cut and raised piece P11 formed by the blade main body A922 of the punching blade A92 is housed in the shelter space A924. Therefore, even if the number of sheets of paper P is relatively large, the punching operation of the punching blade A92 is less likely to be obstructed.

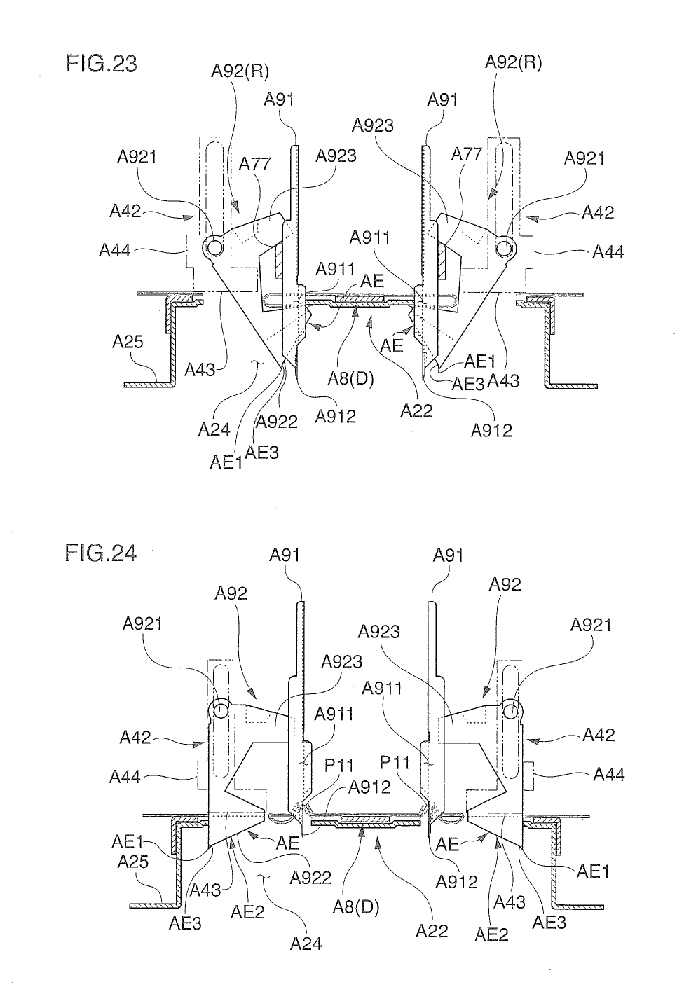

When each of the replaceable blade units A4 moves down, as shown in FIG. 23, a lower face of the arm A923 is set to come in contact with an upper edge of the lock wall A77 provided to the main body A3. If the replaceable blade unit A4 further moves down after the contact, the punching blade A92 can turn to the turning attitude (R) against the elasticity of the coil spring AS3. In other words, the arm A923 is set to come in contact with the upper edge of the lock wall A77 immediately after the punching blade A92 punches the paper P set on the paper base A8 and the blade main body A922 comes to a side under the punching plate A22. If the punching blade A92 further moves down in the contact state, the punching blade A92 can turn to the turning attitude (R). At this time, as the punching blade A92 turns to the turning attitude (R), the pushing-out portion A925 inserts the cut and raised piece P11 into the window A911 in the cutting blade A91.

The paper base A8 is actuated as the replaceable blade units A4 formed as described above move up and down.

As shown in FIGS. 13 and 16 to 18, the paper base A8 is disposed between the stage A2 and the main body A3 in order to support the other face Pb of the paper P. By pivoting back end portions A82 of the paper base A8 on the inner housing A32 of the main body A3, the paper base A8 can turn vertically between a paper raising position (U) raised from the stage A2 and a shelter position (D) in close contact with the stage A2. The paper base A8 is elastically biased toward the paper raising position (U) by coil springs AS1 provided to the stage A2. When the replaceable blade units A4 are moved down by operating the actuating handle A5, the paper base A8 is pressed by the paper retainers A43 to turn from the paper raising position (U) to the shelter position (D) and has windows A81 for allowing the bump portions A223 of the stage A2 to protrude to the one face Pa side in the shelter position (D).

As shown in FIGS. 14 and 16 to 18, the actuating handle A5 includes base portions A51 having front ends A51a supported for rotation and forward and backward sliding on the inner housing A32 through a shaft A54 and the actuation ends A51b positioned at their back ends and connected to the drive shaft A46, arms A52 extending upward from the base portions A51, and a handle A53 provided to outer ends of the arms A52.

In this embodiment, a punching mechanism in the invention is mainly made up of the replaceable blade units A4 retaining the punching blades A92 and the cutting blades A91 and the actuating, handle A5 for pressing the replaceable blade units A4 downward to cause the punching blades A92 and the cutting blades A91 to penetrate the sheets of paper P set on the punching plates A22. A punching blade turning mechanism in the invention is mainly made up of the lower blocks A42 for supporting the shafts A921 of the punching blades A92 for turning, the arms A923 provided to the base ends of the punching blades A92, and the lock walls A77 provided to the main body A3 to receive the arms A923 and apply turning forces to the punching blades A92 when the punching blades A92 move down. A blade withdrawing mechanism is mainly made up of the replaceable blade units A4 retaining the punching blades A92 and the cutting blades A91 and coil springs AS4 which are elastic bodies for biasing the replaceable blade units 4 upward by using the main body A3 as a foothold. By connecting the replaceable blade units 4 and the actuating handle 5 by the shaft A54 as in the embodiment, it is possible to further enhance performance of the blade withdrawing mechanism. In other words, even if there are a large number of sheets of paper P and forces of the coil springs AS4 are not enough to pull the cut and raised pieces P11 out to the one face Pa side of the paper P, it is possible to complete the pulling out by applying an upward operating force to the actuating handle A5. A compressing mechanism in the invention is mainly made up of the bump portions A223 of the punching plates A22 and the bottom wall A71 of the inner housing A32 of the main body A3.

Next, actuation of the binding device A1 will be described.

In a state in which the actuating handle A5 is not operated, as shown in FIGS. 17 and 21, the replaceable blade units A4 are retained in their upper limit positions and the punching blades A92 are maintained in the punching attitudes A92(H). In this state, the plurality of stacked sheets of paper P are inserted all the way through the clearance A71c formed between the upper face of the paper base A8 and the bottom wall A71 of the inner housing A32. Then, by operating the actuating handle A5 downward, the coil springs AS4 start to contract first and the replaceable blade units A4 move down against biasing forces of the coil springs AS4. Immediately after that, the paper retainers A43 come in contact with the one face Pa of the paper P and the paper P and the paper base A8 are pushed down to such a position as to be locked by the stage A2. Then, in the state in which the paper P and the paper base A8 are pressed against the stage A2 by the paper retainers A43, the punching blades A92 and the cutting blades A91 move down to such positions as to come in contact with the one face Pa of the paper P. By further operating the actuating handle A5 downward from this position, in the state in which portions of the paper P around where the punching blades A92 and the cutting blades A91 are to penetrate are firmly fixed by the paper retainers A43, the punching blades A92 and the cutting blades A91 go through a state shown in FIG. 22 and penetrate the paper P to form the binding holes P1 and the cut holes P2 in the paper P. If the punching blades A92 and the cutting blades A91 further move down after the punching, as shown in FIGS. 18 and 23, the arms A923 of the punching blades A92 come in contact with the lock walls A77 and the punching blades A92 turn to the turning attitudes A92(R). As a result, the tip ends of the cut and raised pieces P11 cut and raised out of the binding holes P1 to the other face Pb side of the paper P are inserted into the windows A911 in the cutting blades A91.

Then, by stopping operation of the actuating handle A5, the punching blades A92 return from the turning attitudes A92(R) to the punching attitudes A92(H), the punching blades A92 and the cutting blades 91 move up due to biasing by the coil springs AS4, and the cutting blades A91 and the punching blades A92 go through a state shown in FIG. 24 and are withdrawn from the paper P in the state in which the paper P and the paper base A8 are retained by the paper retainers A43. At this time, the cut and raised pieces P11 inserted into the windows A911 in the cutting blades A91 are pulled out to the one face Pa side of the paper P through the cut holes P2 and the plurality of sheets of paper P are bound by the cutting blades A91. If the punching blades A92 and the cutting blades A91 are withdrawn from the paper P in this manner, the paper base A8 which has been moved down to the shelter position (D) under a load of the punching is moved up to the initial paper raising position (U) by the biasing forces of the coil springs AS1 and the sheets of paper P are separated from the punching plates A22. If the sheets of paper P are withdrawn from the binding device A1 in this state, on their way, as shown in FIG. 26, the sheets of paper P are forcibly guided into a narrow clearance A71d formed between the bottom wall A71 of the inner housing A32 of the main body A3 and the bump portions A223 of the punching plates A22 by guiding effects of the slopes A224 and A74a, the bound portions P3 of the sheets of paper P are compressed and deformed in a thickness direction, and the brochure B described above is formed. If the elastic forces of the coil springs AS4 are not enough to withdraw the punching blades A92 and the cutting blades A91 to the one face Pa side of the paper P, the actuating handle 5 may be operated upward to assist the withdrawal. In FIGS. 21-26, AE3 denotes an adjacent portion adjacent to the blade tip end portion and formed concave curve in a front view.

With the above structure, in the file system according to the embodiment, the plurality of sheets of paper P are bound by the cut and raised pieces P11 cut out of the binding holes P1 similarly to the above-described file system according to the first embodiment. The cut and raised pieces P11 having a function of staples and the paper P are made of the same material, i.e., paper, it is unnecessary to remove the staples in disposal, intricate work such as removal of the metal staples from the paper P is unnecessary, and it is possible to dispose of a large volume of paper P without a lot of time and trouble. Because the bound portions P3 bound by the cut and raised pieces P11 are compressed and deformed into such a state as not to be able to return into shapes immediately after the binding by elasticity of the paper P, it is possible to suppress bulkiness of the bound portions P3. As a result, it is possible to bind a large number of brochure B in the file F to thereby avoid a problem of significant reduction in filing efficiency as compared with a case in which metal staples are used.

In the binding device A1 in the second embodiment, because the main body A3 is fixed to the stage A2, it is possible to increase rigidity of the whole binding device A1 to thereby accomplish stable operation.

Because the respective replaceable blade units A4 are provided separately on the left and right sides, the cutting blades A91 and the punching blades A92 can be replaced easily. Since a space is formed at a central portion of the main body A3, a design which allows an operator to visually recognize the bound portions of the sheets of paper P is possible.

Because the smooth guide portion A915 is formed by rolling and bending down the lower edge of the window A911 in each of the cutting blades A91, the cut and raised piece P11 of the paper P is smoothly guided when it comes in sliding contact with the lower edge of the window A911 as the cutting blade A91 is withdrawn.

Because the pushing-out portion A925 of each of the punching blades A92 is recessed in the partial arc shape, it is possible to effectively suppress or prevent a situation in which the cut and raised piece P11 becomes inappropriately too long to pass through the window A911 in the cutting blade A91 in pressing the cut and raised piece P11. In other words, with this structure, in pressing the cut and raised piece P11 with the pushing-out portion A925 of the punching blade A92, the pushing-out portion A925 preferentially presses opposite edge portions of the cut and raised piece P11. As a result, a contact area between the cut and raised piece P11 and the pushing-out portion A925 reduces to reduce friction to thereby suppress application of irrational force on the base end portion of the cut and raised piece P11. Therefore, it is possible to prevent the situation in which the base end portion of the cut and raised piece P11 ruptures and the cut and raised piece P11 becomes inappropriately long.

The invention is not limited to the above-described embodiments and can be changed in various ways.

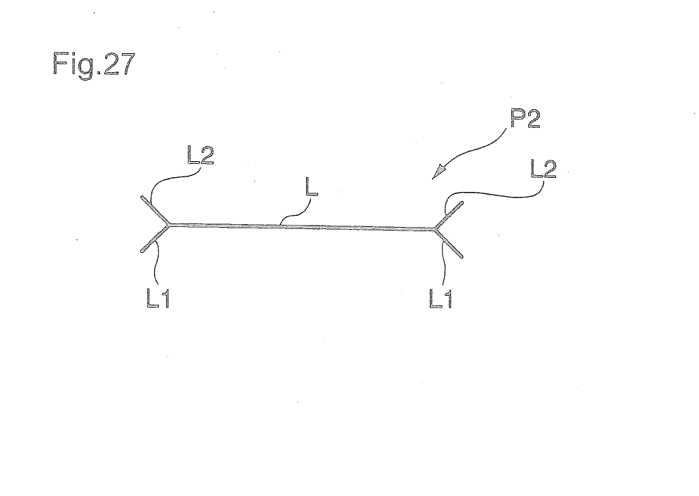

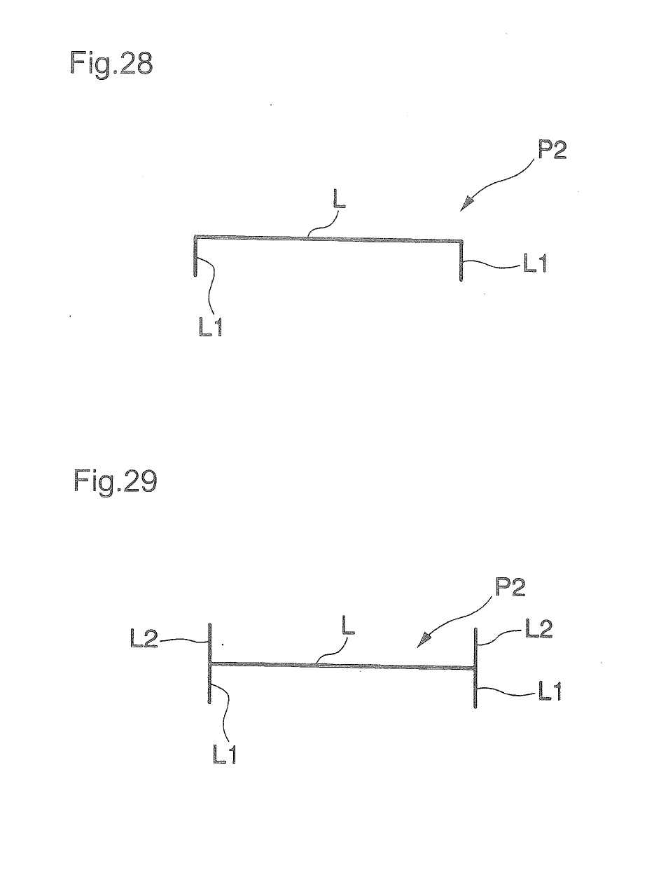

The cut hole P2 does not necessarily have to be in the shape of a straight line but may be a Y-shaped cut hole P2, i.e., the cut hole P2 having Y-shaped opposite ends and made up of a straight main slit L and sub-slits L1 and L2 bending at certain angles to extend from opposite ends of the main slit L in Y shapes as shown in FIG. 27, an angular U-shaped cut hole P2, i.e., the cut hole P2 the entire shape of which is an angular U shape and which is made up of a straight main slit L and sub-slits L1 bending to extend in one direction from opposite ends of the main slit L as shown in FIG. 28, an H-shaped cut hole P2, i.e., the cut hole P2 the entire shape of which is an H shape and which is made up of a straight main slit L, first sub-slits L1 bending to extend in one direction from opposite ends of the main slit L, and second sub-slits L2 bending to extend in the other direction from the opposite ends of the main slit L as shown in FIG. 29, for example.

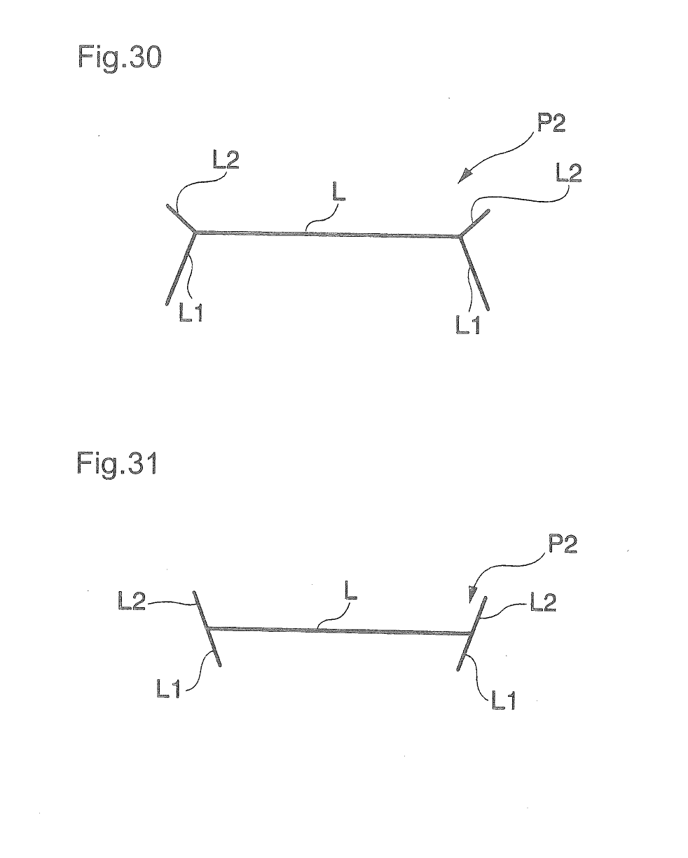

Moreover, as a variation of the cut hole P2 in FIG. 27, first sub-slits L1 may be longer than second sub-slits L2 as shown in FIG. 30. This variation is based on the above-described cut hole P2 in the second embodiment shown in FIGS. 13 to 26.

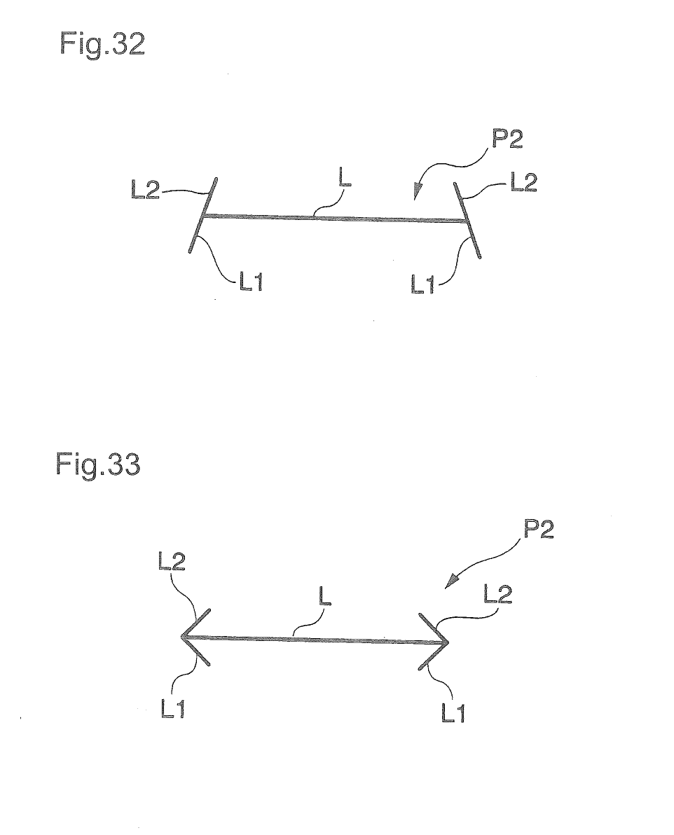

Furthermore, a cut hole P2 shown in FIG. 31 is based on the cut hole P2 shown in FIG. 29 and is substantially in an H shape in which a distance between tip ends of first sub-slits L1 is shorter than a distance between tip ends of second sub-slits L2. A cut hole P2 shown in FIG. 32 is similarly based on the cut hole P2 shown in FIG. 29 and is substantially in an H shape in which a distance between tip ends of first sub-slits L1 is longer than a distance between tip ends of second sub-slits L2. A cut hole P2 shown in FIG. 33 is based on the cut hole P2 shown in FIG. 27 and has a distance between tip ends of first sub-slits L1 and a distance between tip ends of second sub-slits L2 shorter than a main slit L.

As described above, angles of the sub-slits L1 and L2 with respect to the main slit L may be various angles such as 90°, angles greater than 90°, and angles smaller than 90° and it is needless to say that the angles are not limited to those in the examples shown in the drawings.

With such a cut hole P2, a width of the cut and raised piece P11 does not need to be sufficiently small with respect to a width of the cut hole P2. In other words, because the cut sub-slits L1 and L2 are formed at the opposite ends of the straight main slit L of the cut hole P2, even the plurality of sheets of cut and raised piece P11 can be put through the cut hole P2. Because the width of the cut and raised piece P11 can be set to be substantially equal to the width of the cut hole P2, it is possible to suppress lateral displacement of the cut and raised piece P11 and slipping of the cut and raised piece P11 out of the cut hole P2 caused by the displacement. In other words, if the cut hole P2 is in such an angular U shape or an H shape, a dimension of the main slit L can be smaller as compared with that in a straight cut hole P2. As a result, it is possible to suppress the lateral displacement of the cut and raised piece P11 and tearing of the paper P near the cut hole P2 caused by the lateral displacement. Even if the sheets of paper P are relatively thick or the number of sheets of paper P is large, the tongue piece portions P4 and P5 surrounded with the main slit L and the sub-slits L1 and L2 are deformed in the thickness direction of the paper P in the withdrawal of the cutting blade 91 and therefore it is possible to pull up the actuating handle 5 with a smaller operating force. In other words, the coil spring for springing back the actuating handle 5 does not need to be so strong.

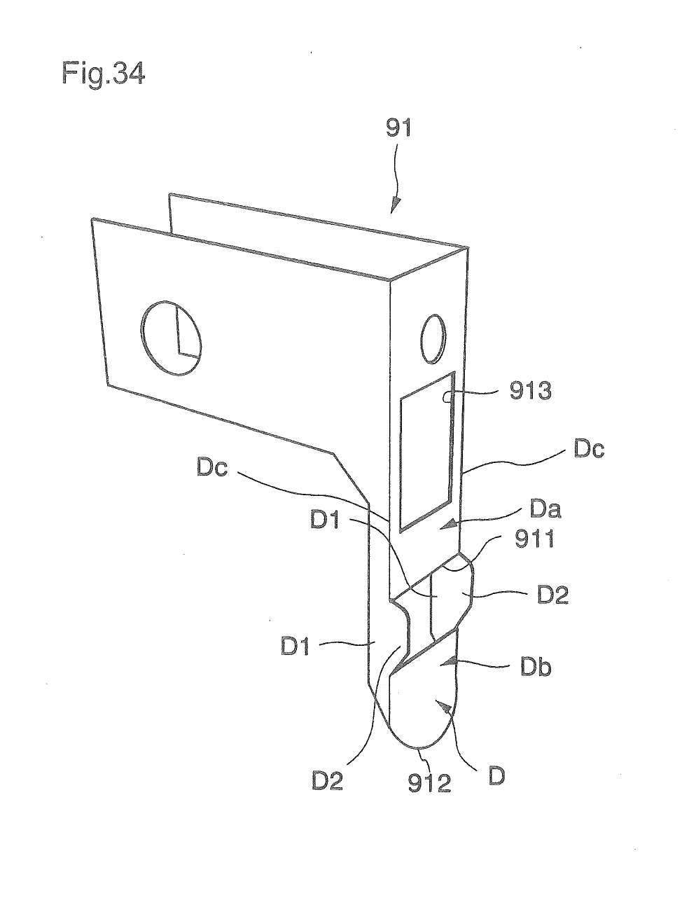

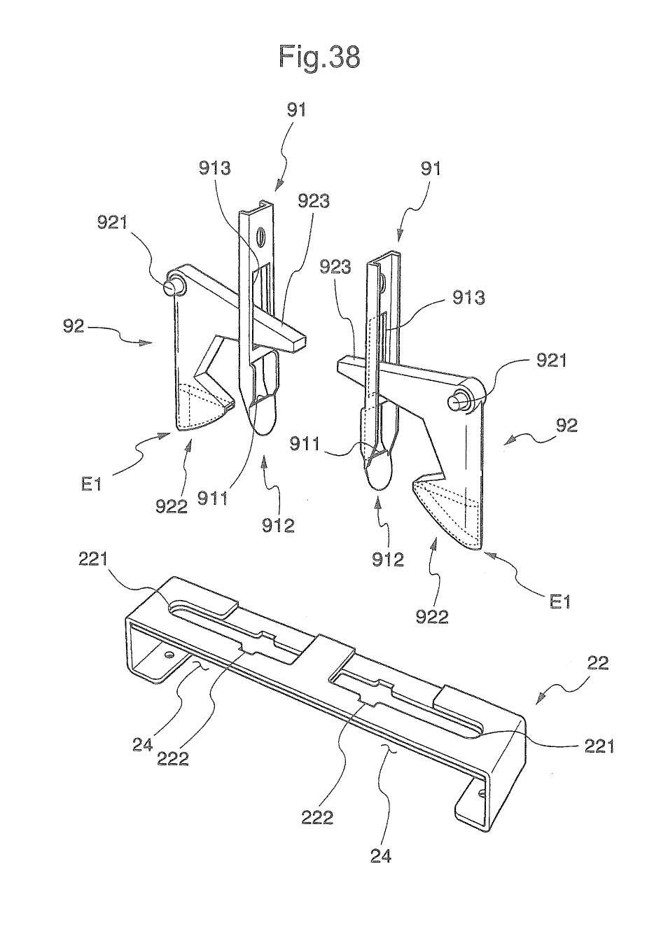

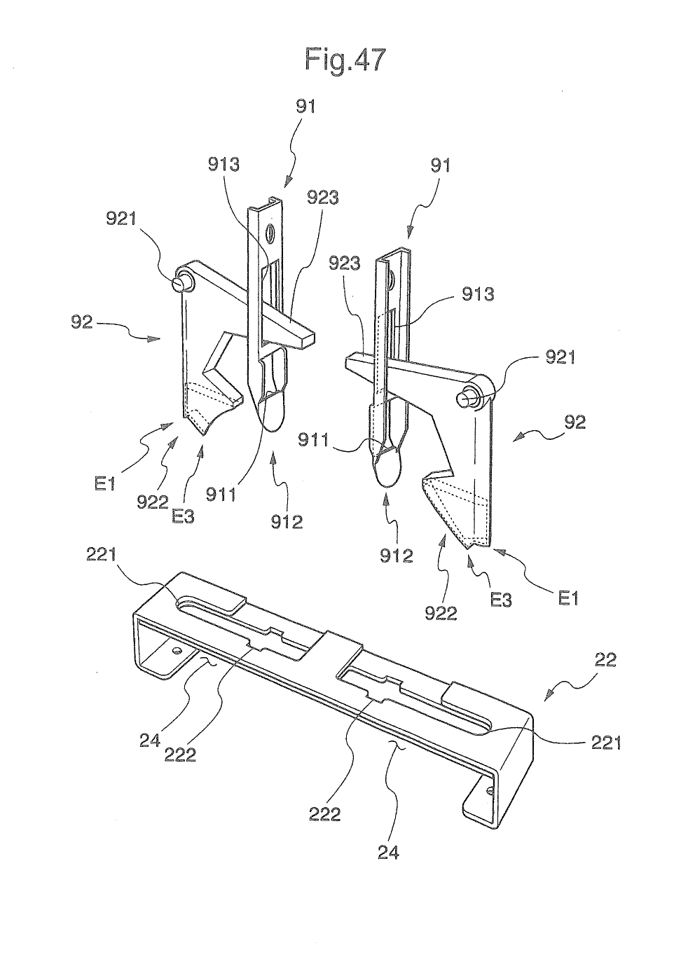

Examples of each of the cutting blades 91 for forming the angular U-shaped or H-shaped cut hole P2 are shown in FIGS. 34, 35, 38, 41, 44, and 47.

In other words, each of the cutting blades 91 is characterized in that it includes the blade main body 912 provided on the tip end side, the window 911 which is provided in an upper portion of the blade main body 912 and through which the cut and raised piece P11 punched out of the paper P as the plurality of sheet bodies passes, and the bent portions D1 and D2 bending at opposite sides of the window 911 in the thickness direction. In other words, the cutting blade 91 is formed by punching and bending the sheet metal material and includes the main blade D for forming the main slit L and the sub-blades D1 and D2 for forming the sub-slits L1 and L2. The main blade D includes the blade main body 912 provided on the tip end side and the window 911 formed throughout the width at the intermediate portion and the sub-blades D1 and D2 are formed by bending at right angles at opposite side edges of the main blade D.

Here, the shape of the blade main body 912 may be a substantially V shape extending upward at certain angles on both sides from a lower end portion or a substantially U shape extending upward while curving from a lower end portion or may be changed in various other ways. The thickness direction refers to an opening direction of the window 911 and the sub-blades D1 and D2 may be bent in opposite directions instead of being bent in one direction. Moreover, angles of the bending may be changed in various ways. If the sub-blades D1 and D2 are bent at right angles in the thickness direction, the angular U-shaped cut hole P2 or the H-shaped cut hole P2 can be formed. If the sub-blades D1 and D2 are bent at angles smaller than 90°, the Y-shaped cut hole P2 can be formed.

With this cutting blade 91, it is possible to form the cut hole P2 having the main slit L and the sub-slits L1 and L2 bending at right angles to extend from the opposite ends of the main slit L in the plurality of sheets of paper P. Especially because the sub-blades D1 and D2 are bent at right angles at the opposite sides of the window 911, a dimension of the main slit L and the width of the cut and raised piece P11 punched out of the paper P can be set to be substantially equal to each other. Therefore, the main slit L can be made smaller than when the cut hole P2 is in the shape of the straight line. Moreover, it is possible to suppress the lateral displacement of the cut and raised piece P11 and tearing of the paper P near the cut hole P2 caused by the lateral displacement. Although it is of course possible to apply the cutting blades 91 to the plurality of binding holes P2, the cutting blade 91 is especially effective in the case of forming only one binding hole P2, in which lateral displacement is likely to occur. Even if the sheets of paper P are relatively thick or the number of sheets of paper P is large, the tongue piece portions P4 and P5 surrounded with the main slit L and the sub-slits L1 and L2 are deformed in the thickness direction of the paper P in the withdrawal of the cutting blade 91 and therefore it is possible to pull up the actuating handle 5 with a smaller operating force. In other words, the coil spring for springing back the actuating handle 5 does not need to be so strong.

(H shape) To put it concretely, an example of the cutting blade 91 for forming the H-shaped cut hole P2 made up of the straight main slit L, the first sub-slits L1 bending to extend in one direction from opposite ends of the main slit L, and the second sub-slits bending to extend in the other direction from the opposite ends of the main slit L is shown in FIG. 34. In other words, the cutting blade 91 is formed by punching and bending a sheet metal material and includes a main blade D for forming the main slit L, first sub-blades D1 for forming the first sub-slits L1, and second sub-blades D2 for forming the second sub-slits L2. The main blade D is divided into an upper blade portion Da and a lower blade portion Db having a blade main body 912 by a window 911 for receiving the punching blade 92 and the upper blade portion Da and the lower blade portion Db are structurally connected by the first sub-blades D1. The first sub-blades D1 have base end edges which are integrally continuous with opposite side edges of the main blade D at perpendicularly bent line portions Dc and the second sub-blades D2 are continuously formed flush with portions of the base end edges of the first sub-blades D1 and corresponding to the window 911. In other words, the second sub-blades D2 are cut and raised out of the window 911 by bending the sheet metal material at the perpendicularly bent line portions Dc. Because the first sub-blades D1 and the second sub-blades D2 are respectively formed by bending the one main blade D in this manner, it is possible to obtain strength of the whole cutting blade 91. On a base end side of the main blade D of the cutting blade 91, a through hole 913 through which the arm 923 pass is formed to prevent interference between the cutting blade 91 and the arm 923 provided to the punching blade.

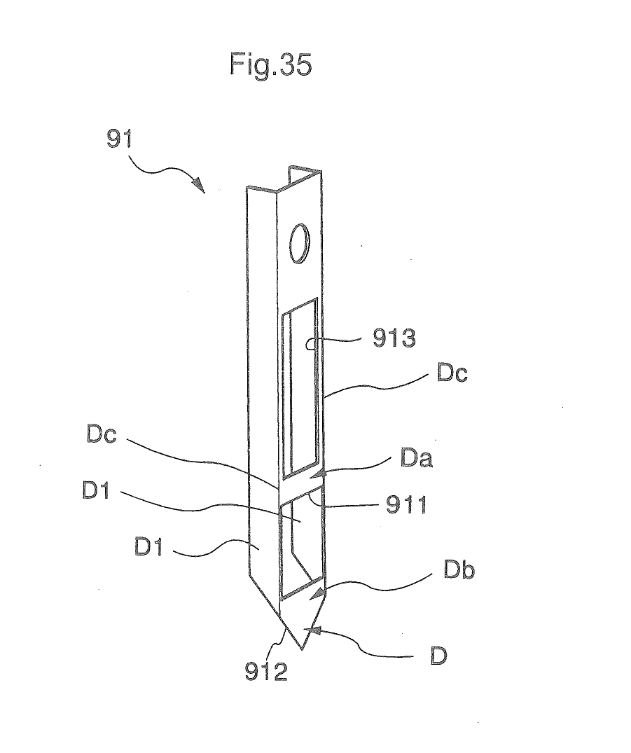

(Angular U shape) An example of the cutting blade 91 for forming the angular U-shaped cut hole P2 made up of the straight main slit L and the sub-slits L1 bending to extend in one direction from opposite ends of the main slit L is shown in FIG. 35. In other words, the cutting blade is formed by punching and bending a sheet metal material and includes a main blade D for forming the main slit L and sub-blades D1 which are bent portions for forming the sub-slits L1. The main blade D is divided into an upper blade portion Da and a lower blade portion Db having a blade main body 912 by a window 911 for receiving the cut and raised piece P11 punched out of the paper P and the punching blade 92 and the upper blade portion Da and the lower blade portion Db are structurally connected by the sub-blades D1. The sub-blades D1 have base end edges which are integrally continuous with opposite side edges of the main blade D at perpendicularly bent line portions Dc. On a base end side of the main blade D of the cutting blade 91, a through hole 913 through which the arm 923 pass is formed to prevent interference between the cutting blade 91 and the arm 923 provided to the punching blade 92.

Each of the cutting blades A91 is not limited to the above-described double-edged structure. For example, each of the blade main body A912 of the cutting blade A91, i.e., an edge formed at the main blade AD and edges formed at the first sub-blades AD1 and the second sub-blades AD2 may have an outer edge structure having a cutting edge only on an outer side of the thickness of the material or may have an inner edge structure having a cutting edge only on an inner side of the thickness of the material. With the outer edge structure, whether the blade is bent into the angular U shape or the H shape, it is possible to form a continuous and unbroken cut edge of the cut hole P2, which improves an appearance of the cut edge. With the outer edge structure, however, an entire length of the cutting edge increases, which increases resistance when the cutting blade penetrates the paper. On the other hand, if the cutting blade A91 has the inner edge structure, it is possible to solve the problem of the increase in the resistance when the cutting blade A91 penetrates the paper P. With the inner edge structure, however, the cut hole P2 is broken, which impairs an appearance of the cut edge of the cut hole P2, and also distances between the sub-slits L1 and L2 of the cut hole P2 become smaller than front-back distances between the first sub-blades AD1 and the second sub-blades AD2 by distances corresponding to the thickness of the cutting edge A91. In other words, with the double-edged structure having the cutting edge at the center of the thickness of the material as shown in the second embodiment, it is possible to solve the above-mentioned problems at once and it is also possible to suppress a problem of a warp in the blade, which is likely to occur in the outer edge structure or the inner edge structure having the cutting edge only on one side.

Each of the punching blades 92 is not limited to one in the embodiments, either.

For example, if the number of sheets of paper P in which binding holes P1 are to be formed increases, a force required to form the holes increases. Especially when the punching blade 92 in the first embodiment is used, a greater force is required to cause the blade main body 922 of the punching blade 92 to penetrate the paper P first than to gradually form the binding hole P2 after a part of the blade main body 922 penetrates. In other words, in pressing the actuating handle 5, bounce received from the paper P becomes excessively large when the blade main body 922 of the punching blade 92 first comes in contact with the paper P while the bounce reduces sharply when the blade main body 922 penetrates after the first contact. Therefore, feeling of strangeness may be caused in operation in some cases.

To solve such a problem, each of the punching blades 92 is preferably formed as follows. In other words, the punching blade 92 is characterized in that it includes the blade main body 922 provided on the tip end side, the shaft 921 provided on the base end side, and the arm 923 for turning the punching blade 92 by means of this shaft 921 and that the blade main body 922 is the sharpest at a blade tip end portion E1. In other words, a cutting edge E of the blade main body 922 is inclined, i.e., at an entry angle with respect to the punching plate 22 disposed horizontally and the entry angle (hereafter referred to as the “entry angle θ” is the largest at the blade tip end portion E1.

Here, the blade tip end portion E1 is a portion of the blade main body 922 which enters the paper P first. The entry angle θ at the blade tip end portion E1 does not necessarily have to be greater than the entry angle θ at the other portion E2 of the blade main body 922 and the cutting edge E may have the constant entry angle θ from the blade tip end portion E1.

With this punching blade 92, it is possible to relatively reduce the operating force applied to the actuating handle 5 in starting to form the binding hole P1, i.e., when the punching blade 92 starts to come in contact with the paper P. Once the blade tip end portion E1 has entered the paper P, the other portion E2 of the blade main body 922 follows the portion which has entered first while an appropriate amount of bounce is maintained. Therefore, the bounce when the actuating handle 5 is pressed does not increase or decrease to thereby eliminate the feeling of strangeness in operation.

Preferably, in the punching blade 92, the shelter space 924 for allowing the cut and raised piece P11 cut and raised by the blade main body A922 to shelter is provided above the blade main body 922 and the pushing-out portion 925 for inserting the cut and raised piece P11 into the window 911 formed in the cutting blade 91 is provided above the shelter space 924. With this punching blade 92, even if the number of sheets of paper P is relatively large, the cut and raised piece P11 formed by the blade main body 922 of the punching blade 92 is housed in the shelter space 924 to thereby suppress obstruction of the punching operation of the punching blade 92. The cut and raised piece P11 housed temporarily into the shelter space 924 is inserted into the window 911 in the cutting blade 91 by the pushing-out portion 925 as the punching blade 92 turns.

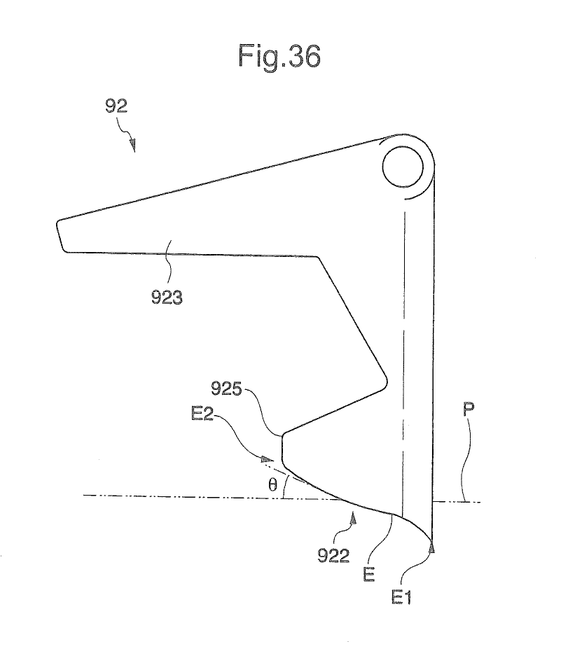

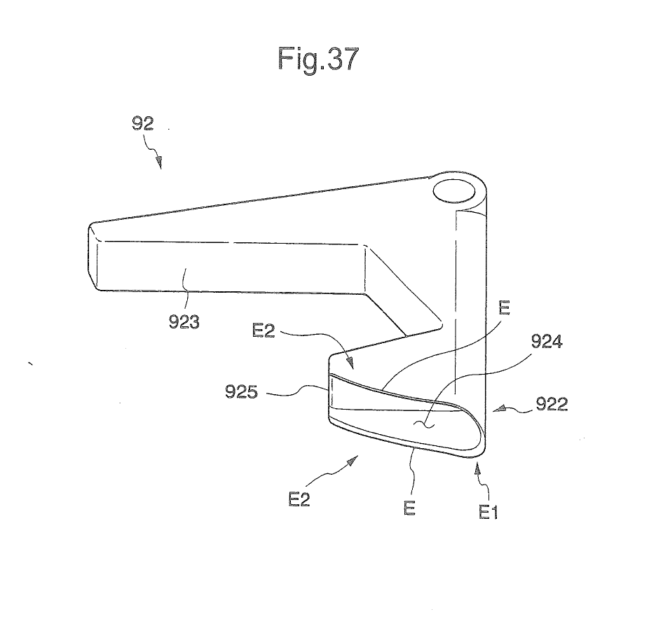

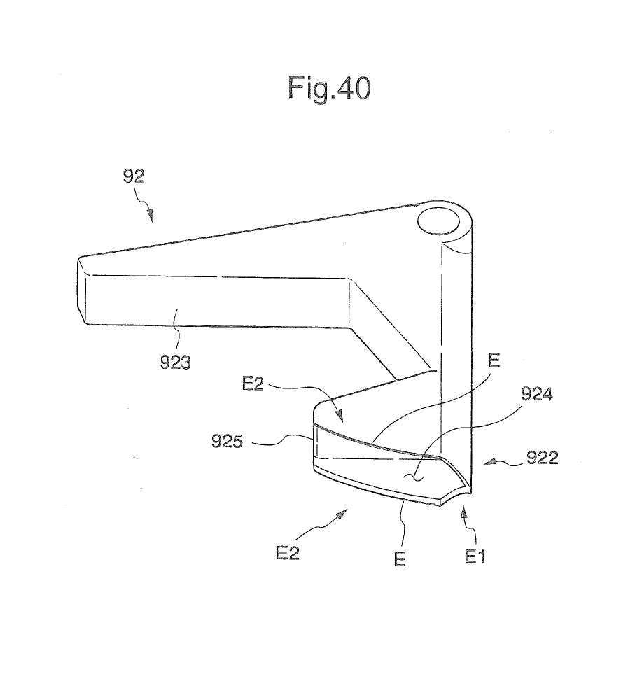

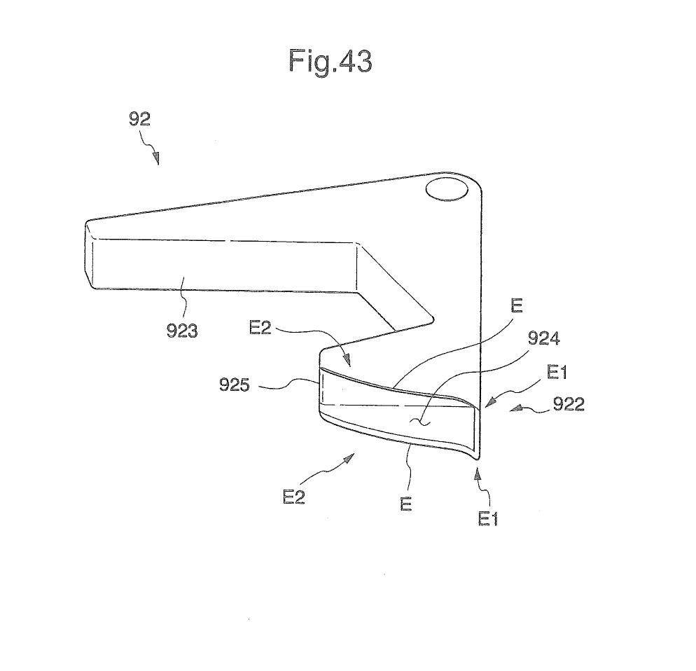

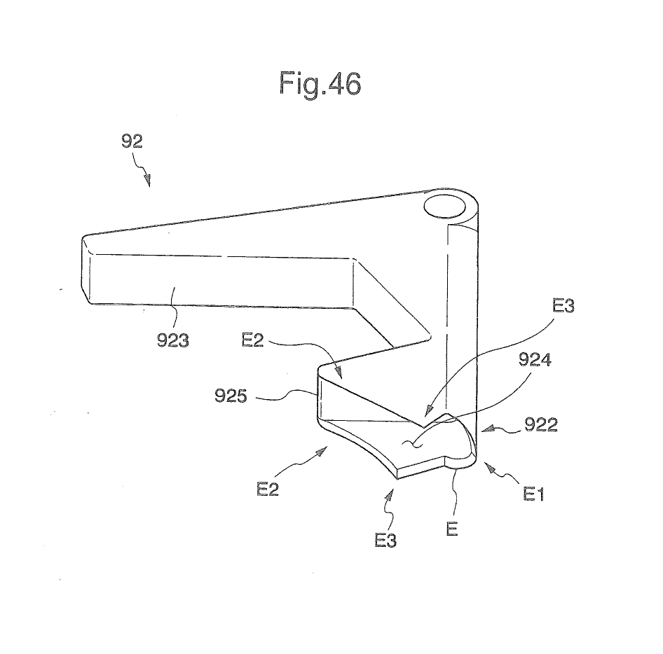

To put it concretely, examples of the punching blade are shown in FIGS. 36 to 47.

(At Present) Although the punching blade shown in the second embodiment is made up of the core and the outer covering, the blade is not limited to this structure. Instead, the whole punching blade may be made of metal as follows. In other words, as shown in FIGS. 36 to 38, the punching blade 92 includes the shaft 921 at its base end portion and the blade main body 922 for forming the binding hole P1 at its tip end and the shaft 921 is detachably supported on the punching blade retaining portion 412 provided to the ceiling wall of the replaceable blade unit 4. From the base end of the punching blade 92, an arm 923 for turning the punching blade 92 protrudes.

The blade main body 922 is provided at the lower end portion of the punching blade 92 and has the cutting edge E continuous in the U shape in the bottom view. The cutting edge E has a shape formed by a smooth curved line and is inclined so that its angle with respect to the punching plate 22 at a position of contact between the punching blade 92 and the punching plate 22 changes as the punching blade 92 penetrates. The inclined portion includes the blade tip end portion E1 which penetrates the paper P first. In other words, an entry angle 8 which the cutting edge E makes with the punching plate 22 at the blade tip end portion E1 is set to be greater than the entry angle θ at the other portion E2 of the blade main body 922. Therefore, when the blade main body 922 penetrates the paper P, the blade tip end portion E1 first comes in contact with a portion of the paper P, which is almost a point, and then punching is carried out while a punching distance by the blade main body 922 and the cutting edge E increases with respect to their penetrating distance.

In the upper space surrounded with the cutting edge E, the shelter space 924 for allowing the cut and raised piece P11 cut and raised by the blade main body 922 to shelter is provided and the pushing-out portion 925 for inserting the cut and raised piece P11 into the window 911 formed in the cutting blade 91 is provided above the shelter space 924.

The punching blades 92 pairing up with each other are disposed with the tip ends of their arms 923 facing each other and retained in the punching attitudes (H) in which the blade main bodies 922 are disposed substantially right under the shafts 921 with their arms 923 biased downward by the common elastic body, e.g., the coil spring S3. At this time, the cut and raised pieces P11 formed by the blade main bodies 922 of the punching blades 92 are housed in the shelter spaces 924. Therefore, even if the number of sheets of paper P is relatively large, the punching operation of the punching blades 92 is less likely to be obstructed.

When the replaceable blade unit 4 moves down, a lower face of each of the arms 923 is set to come in contact with an upper edge of the lock wall 77 provided to the main body 3. If the replaceable blade unit 4 further moves down after the contact, the punching blade 92 can turn into the turning attitude (R) against the elasticity of the coil spring S3. In other words, the arm 923 is set to come in contact with the upper edge of the lock wall 77 immediately after the punching blade 92 punches the paper P set on the paper receiving face 61 and the blade main body 922 comes to the side under the punching plate 22. If the punching blade 92 further moves down in the contact state, the punching blade 92 can turn to the turning attitude (R). At this time, as the punching blade 92 turns to the turning attitude (R), the pushing-out portion 925 inserts the cut and raised piece P11 into the window 911 in the cutting blade 91.

The punching plate 22 is made of metal and has punching portions 221 through which the punching blades 92 pass and passage holes 222 through which the cutting blades 91 pass and cavities 24 allowing insertion of the punching blades 92 and the cutting blades 91 and turning of the inserted punching blades 92 are formed under the punching plate 22. The passage holes 222 in the punching plate 22 according to the variation have dimensions corresponding to widths of the first sub-blades D1 and the second sub-blades D2 on the assumption that the cutting blades 91 for forming the H-shaped cut holes P2 are used, for example.

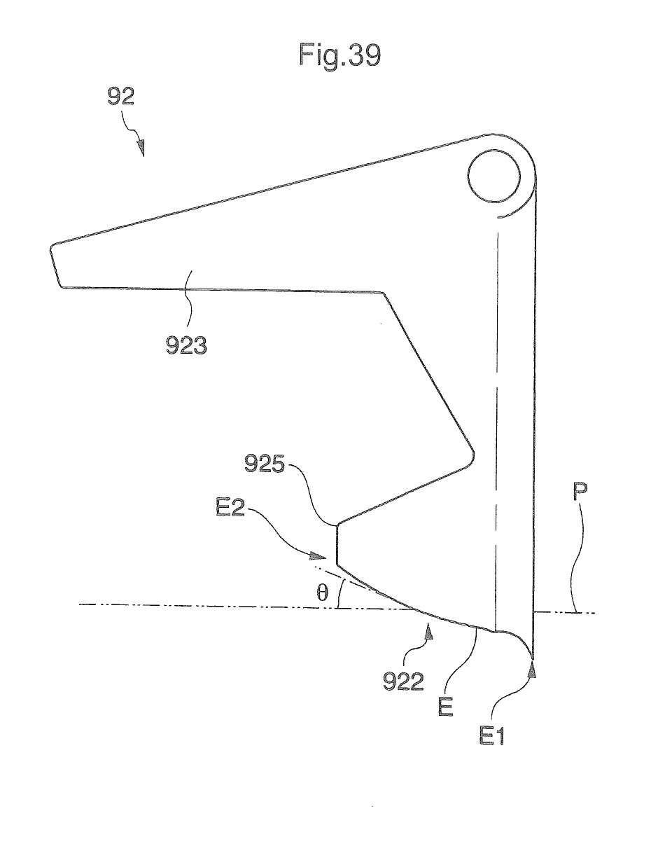

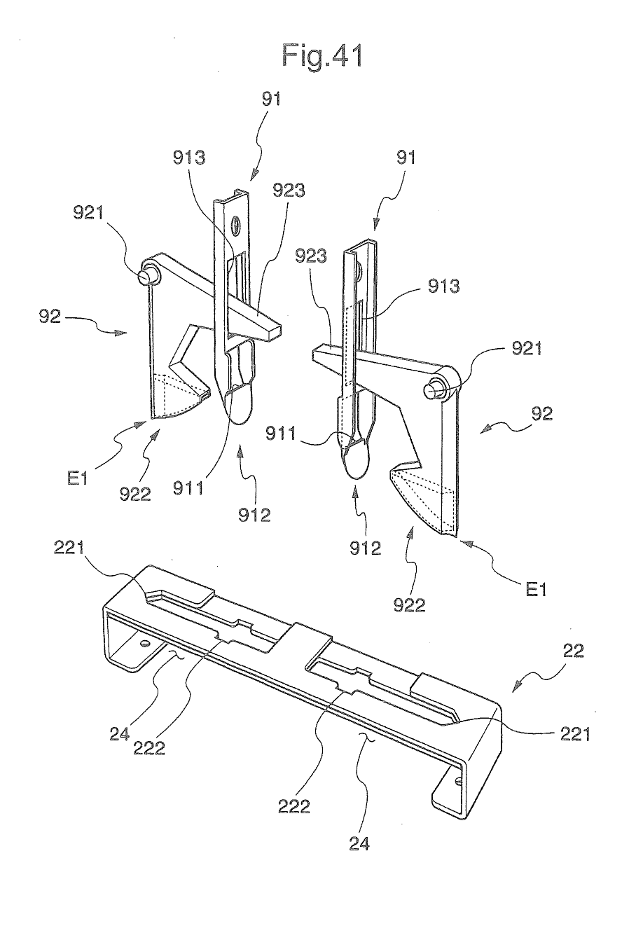

(Center Edge) As shown in FIGS. 39 to 41, as a variation of this punching blade 92, a punching blade 92 having a cutting edge E continuous in a V shape in a bottom view to form a binding hole P1 so that a cut and raised piece P11 has a triangular tip end can be considered. In the punching plate 22 when such punching blades 92 are used, opposite ends of the punching portions 221 preferably have corner portions corresponding to the bottom shapes of the punching blades 92 as shown in FIG. 41.

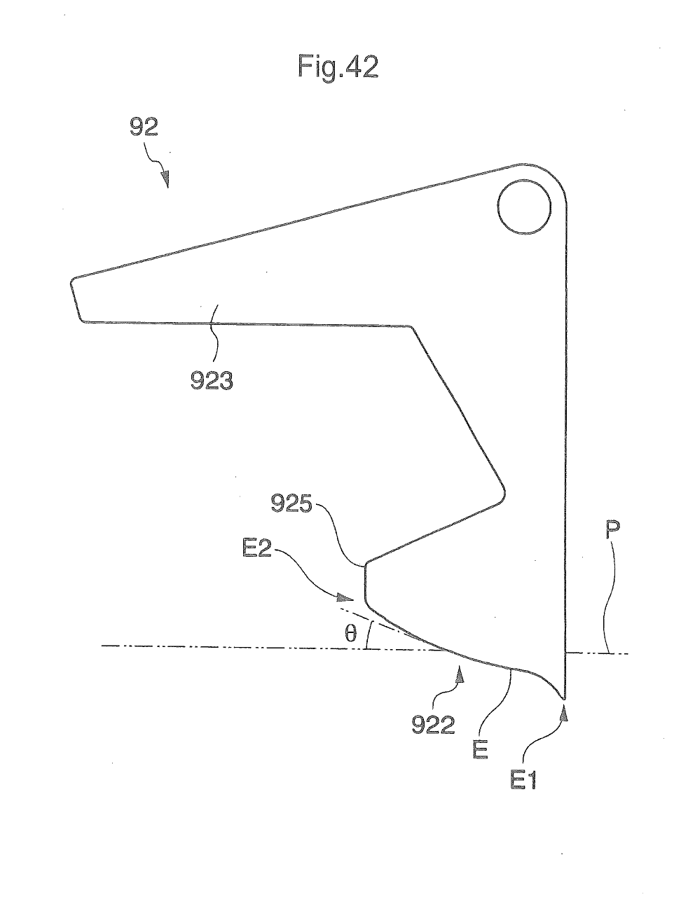

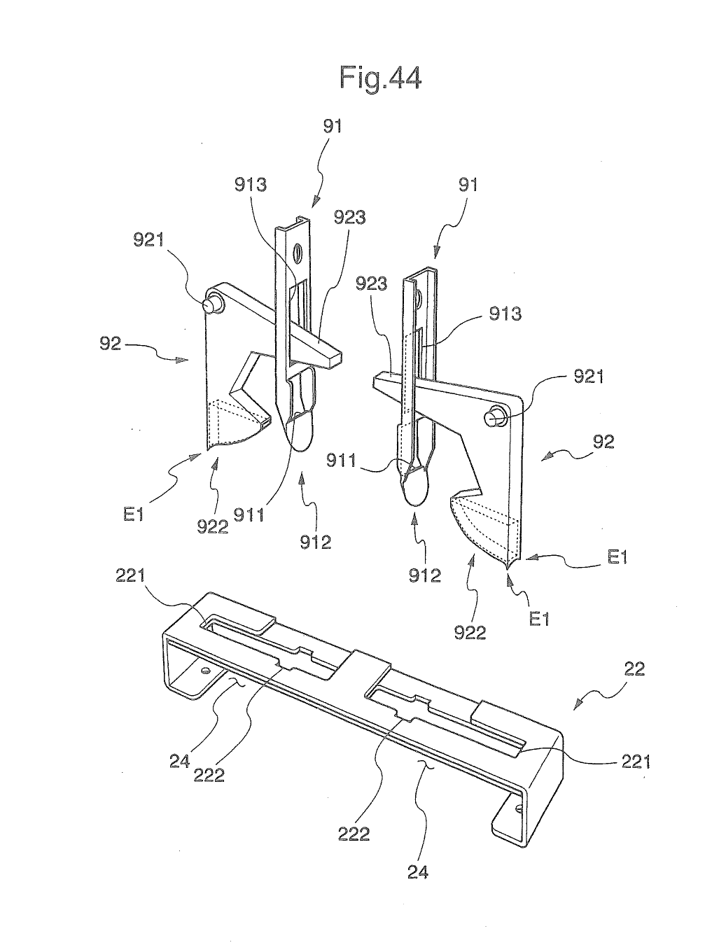

(Corner Edge) As another variation, as shown in FIGS. 42 to 44, a punching blade 92 having a cutting edge E continuous in an angular U shape in a bottom view to form a binding hole P1 so that a cut and raised piece P11 has a square tip end can be considered. As shown in FIG. 44, in the punching plate 22 when the punching blades 92 are used, opposite ends of the punching portions 221 preferably have corner portions corresponding to the bottom shapes of the punching blades 92.

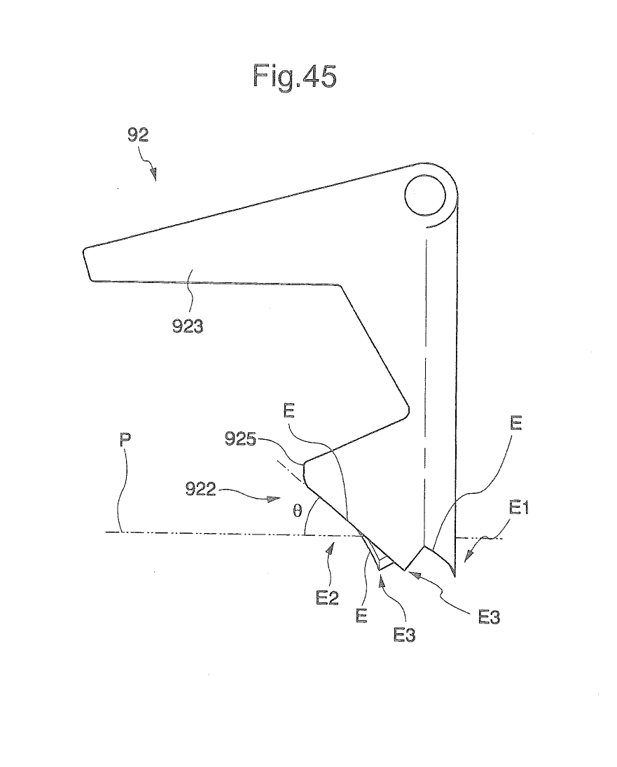

(Three edges) As another variation, as shown in FIGS. 45 to 47, a punching blade 92 has a cutting edge E continuous in a U shape in a bottom view. The cutting edge E is a combination of shapes of a curved line and straight lines and is inclined so that its angle with respect to the punching plate 22 at a position of contact between the punching blade 92 and the punching plate 22 changes as the punching blade 92 penetrates. The inclined portion includes a blade tip end portion E1 which penetrates the paper P first and a second blade tip end portion E3 which penetrates the paper P substantially simultaneously or slightly later at two positions. An entry angle θ which the cutting edge E makes with the punching plate 22 at the blade tip end portion E1 is set to be greater than the entry angle θ at the other portion E2 of the blade main body 922.

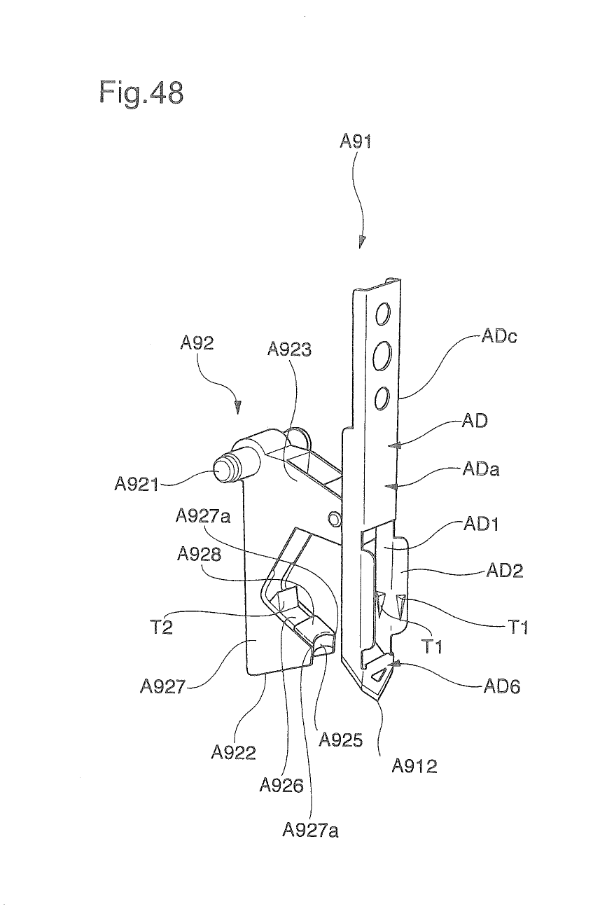

Although each of the cutting blades A91 in the above-described embodiments has a common-sense shape to minimize snagging of the paper P by the cutting blade A91 in withdrawing the cutting blade A91, the cutting blade A91 may be formed to intentionally snag the paper P when it is withdrawn as shown in FIG. 48. In other words, the common-sense cutting blade A91 is withdrawn from the paper P with the edge of the slit L sunk to the lower face, i.e., to the other face Pb side in order to smoothly slide with respect to the paper P in the withdrawal. However, there is a great deal of resistance to insertion of the cut and raised piece P11 made up of the large number of sheets of paper P into the slit L when the edge of the slit L is sunk to the other face Pb side. However, if protrusions T1 which can be inserted with little resistance and facilitate snagging of the paper P in withdrawal are provided on inner sides of the sub-blades AD1 and AD2, for example, of the cutting blade A91 as shown in FIG. 48, the edge of the slit L reverses to the upper face, i.e., to the one face Pa side in the withdrawal and it becomes easy to put the cut and raised piece P11 through the slit L. To put it concretely, each of the protrusions T1 has a cross-sectional shape gradually becoming smaller in a downward direction. To put it more concretely, the protrusion T1 is in a shape of a triangular pyramid with its tip end oriented downward. Such protrusions T1 are preferably provided in such positions as to facilitate snagging of the tongue piece portions P4 and P5 and are provided on the inner faces of the first sub-blade portions AD1 and the second sub-blade portions AD2 to pair up with each other in the cutting blade A91 shown in FIG. 48. The number and the positions of the protrusions T1 are not especially limited to the above. Instead, only one protrusion T1 may be provided or the plurality of protrusions may be provided on upper and lower sides.

Although the pushing-out portion A925 formed at the tip end of the punching blade A92 presses the cut and raised piece P11 has been described in the above-described embodiment, a protrusion T2 for pressing the base end portion of the cut and raised piece P11 prior to the pressing by the pushing-out portion A925 in an early stage of turning may be provided to the punching blade A92 as shown in FIG. 48. When the number of sheets of paper P to be treated is relatively small, it is possible to reduce a force for pulling up the cut and raised piece P11 and inserting it through the slit L by folding the cut and raised piece P11 through almost 180° at the base end portion to make a crease in advance in this manner.

Moreover, as shown in FIG. 48, a resin contact portion A928 may be provided to an upper portion of the pushing-out portion A925 to prevent tip end upper edges A927a of the metal outer covering A927 of the punching blade A92 from coming in direct contact with the paper P when the punching blade A92 moves from the punching attitude (H) to the turning attitude (R). If the above-described binding device A1 has been used for a length of time, the punching blade A92 is displaced in the front-back direction due to wear of parts and the like. In this case, it is highly possible that the cut and raised piece P11 which used to be pushed out by the pushing-out portion A925 comes in contact with the tip end upper edges A927a of the metal outer covering A927 disposed on opposite sides of the pushing-out portion A925 and is pushed out. As a result, the tip end upper edges A927a may damage the cut and raised piece P11. However, if the resin contact portion A928 is provided to the tip end upper edges A927a, the resin contact portion A928 comes in contact with the cut and raised piece P11 of the paper P before the tip end upper edges A927a of the punching blade A92 to thereby prevent the damage to the cut and raised piece P11, even if the punching blade A92 is displaced.

Instead of providing the resin contact portion A928, the tip end upper edges A927a of the metal outer covering A927 of the punching blade A92 may be rounded to eliminate angular portions.

Besides the smooth guide portion formed by rolling and bending down the surplus material at the lower edge of the window, the smooth guiding portion may be changed in various ways if it can suppress the angular state of the lower edge of the window to prevent damage to or tearing of the paper by rounding the lower edge of the window by grinding it or by attaching a separate body to the lower edge of the window.

Furthermore, the punching blade is not limited to one made up of the core and the outer covering but may be integrally formed by machining metal material.

The brochure is not limited to one formed by binding the plurality of sheets of paper but may be one formed by binding a plurality of plastic sheet bodies, for example, and may be changed in various ways if it is made up of a plurality of sheet bodies made of the same material.

The binding rods may be changed in various ways and may be elastically deformable wires or flexible strings. Instead of the above-described two biding rods, one binding rod may be employed. Moreover, the number of binding holes is not limited to two, either. Although it is needless to say that the file system and the binding device according to the embodiments can be employed when there are the plurality of binding holes, the system and device are effective when only one biding hole is provided as well. In other words, the sheets of paper may be displaced from each other around the binding hole or the sheets of paper near the cut hole are likely to tear due to the displacement when there is only one binding hole as compared with the case of the plurality of binding holes. However, it is possible to effectively suppress such a problem.

The shape and size of the binding holes are not limited to those shown in the embodiments but may be changed in various ways.

Although the embodiments have been described above in detail, the invention is not limited to the embodiments and specific structures of other respective portions may be changed in various ways without departing from the gist of the invention.

### EXPLANATION OF REFERENCE NUMERALS

B . . . brochure
P . . . paper
Pa . . . one face
Pb . . . the other face
P1 . . . binding hole
P11 . . . cut and raised piece
P2 . . . cut hole
P3 . . . bound portion
F . . . file
F1 . . . cover
F2 . . . binder
F21 . . . binding rod
1, A1 . . . binding device
2, A2 . . . stage
22, A22 . . . punching plate
91, A91 . . . cutting blade
911, A911 . . . window
92, A92 . . . punching blade
(H) . . . punching attitude
(R) . . . turning attitude

1. A blade which is a part of a binding device forming a binding hole and a cut hole and binding a plurality of sheet bodies together by using a cut and raised piece cut and raised out of the binding hole and the cut hole, the blade comprising:
a core;
an outer covering comprising a sheet metal and covering an outside of the core; and
a cutting edge including a curved portion having a curved arc shape in a bottom view and liner portions extending from both ends of the curved portion in the bottom view, the cutting edge being continuous in a U shape and formed at a tip end of the outer covering, the curved portion comprising:
a blade tip end portion which first comes in contact with a sheet bodies, a portion of which includes substantially a point, in starting to form a hole before sharply stuck into the sheet bodies; and
an adjacent portion adjacent to the blade tip end portion and formed concave curve in a front view, the cutting edge except the blade tip end portion and the adjacent portion being formed liner in the front view.

2. The blade according to claim 1, wherein the cutting edge is sharpest at the blade tip end portion.

3. The blade according to claim 1, wherein the binding device includes a punching plate for forming the binding holes in the sheet bodies in cooperation with the blade, and the cutting edge is inclined at an entry angle, which one face of the sheet bodies supported on the punching plate makes with the cutting edge immediately before entering the sheet bodies, and the entry angle is set to gradually reduce as the blade penetrates.

4. The blade according to claim 1, wherein the binding device includes a punching plate for forming the binding holes in the sheet bodies in cooperation with the blade, and the cutting edge is inclined for the blade tip end portion first comes in contact with the portion of the sheet bodies, which includes substantially the point, and then punching is carried out while a punching distance by the cutting edge increases with respect to their penetrating distance.

5. The blade according to claim 1, wherein the binding device includes a cutting blade for forming the cut hole and comprising a window for receiving the blade in a turning attitude.

6. The blade according to claim 5, wherein the window receives a portion of a blade main body with the cutting edge which has turned to the turning attitude.

7. The blade according to claim 5, wherein the binding device includes an actuating handle to cause the blade and the cutting blades to penetrate the sheet bodies, turning from a punching attitude to the turning attitude by operating the actuating handle.

8. The blade according to claim 5, further comprising:
a shelter space for allowing the cut and raised piece cut and raised by the blade main body with the cutting edge to shelter in an upper space surrounded with the cutting edge; and
a pushing-out portion for inserting the cut and raised piece into the window above the shelter space.

9. The blade according to claim 8, wherein the pushing-out portion is recessed in a partial arc shape in a plan view and preferentially biases opposite side edges of the cut and raised piece.

10. The blade according to claim 8, further comprising:
a protrusion for pressing a base end portion of the cut and raised piece prior to the pressing by the pushing-out portion.

11. The blade according to claim 8, wherein the core comprises a resin, the outer covering comprises a sheet metal and covering a resin, the outer covering comprises a sheet metal and covering an outside of the core, and the pushing-out portion is formed by the core.

12. The blade according to claim 1, further comprising:
a resin contact portion provided to the tip end upper edges of the outer covering and coming in contact with the cut and raised piece before the tip end upper edges.

13. A binding device, comprising:
the blade according to claim 1, including the core, the outer covering, the cutting edge, the curved portion, the liner portions, the blade tip end portion, and the adjacent portion.
